(19) United States
(12) Patent Application Publication
(10) Pub. No.: US 2026/0173189 A1
(43) Pub. Date: Jun. 18, 2026

(54) INFORMATION PROCESSING APPARATUS, PROGRAM, SYSTEM, AND INFORMATION PROCESSING METHOD

(71) Applicant: SoftBank Corp., Tokyo (JP)

(72) Inventors: Liang ZHANG, Tokyo (JP); Teruya FUJII, Tokyo (JP)

(21) Appl. No.: 19/533,272

(22) Filed: Feb. 8, 2026

Related U.S. Application Data
(63) Continuation of application No. PCT/JP2024/028942, filed on Aug. 13, 2024.

(30) Foreign Application Priority Data
Aug. 15, 2023 (JP) 2023-132327

(51) Int. Cl. H04W 76/15; H04W 4/40; H04W 76/14

(52) U.S. Cl. CPC H04W 76/15; H04W 76/14; H04W 4/40

(57) ABSTRACT

Provided is information processing apparatus including a first pairing unit which establishes a first pairing between a first operation apparatus and a drone, an instruction acquisition unit which acquires an operation authority switch instruction for instructing the switching of an operation apparatus having an operation authority over the drone from the first operation apparatus to a second operation apparatus, a second pairing unit which establishes, in response to the instruction acquisition unit having acquired the operation authority switch instruction, while the drone is flying, a second pairing between the second operation apparatus and the drone, and a switch unit which switches, in response to the second pairing unit having established the second pairing, the operation apparatus having the operation authority over the drone from the first operation apparatus to the second operation apparatus.

The contents of the following patent application(s) are incorporated herein by reference:

NO. 2023-132327 filed in JP on Aug. 15, 2023;

NO. PCT/JP2024/028942 filed in WO on Aug. 13, 2024.

### BACKGROUND

### 1. Technical Field

The present invention relates to an information processing apparatus, a program, a system, and an information processing method.

### 2. Related Art

Patent Document 1 describes a controller terminal which decides, when a shooting range is designated on a map in a case where a wide area is shot, what flight routes and altitudes a wireless aircraft may use to carry out the shooting.

### RELATED ART DOCUMENT

### Patent Document

Patent Document 1: Japanese Patent Application Publication No. 2017-046328

### BRIEF DESCRIPTION OF THE DRAWINGS

FIG. 1 schematically illustrates an example of a system 10.

FIG. 2 is a schematic diagram for describing an example of a pairing.

FIG. 3 is an explanatory diagram for describing an example of a process flow of the system 10.

FIG. 4 is an explanatory diagram for describing an example of the process flow of the system 10.

FIG. 5 is an explanatory diagram for describing an example of the process flow of the system 10.

FIG. 6 schematically illustrates an example of a functional configuration of an information processing apparatus 200.

FIG. 7 is an explanatory diagram for describing another example of the process flow of the system 10.

FIG. 8 is an explanatory diagram for describing another example of the process flow of the system 10.

FIG. 9 is an explanatory diagram for describing another example of the process flow of the system 10.

FIG. 10 schematically illustrates another example of a functional configuration of the information processing apparatus 200.

FIG. 11 schematically illustrates an example of a pairing group.

FIG. 12 is an explanatory diagram for describing another example of the process flow of the system 10.

FIG. 13 is an explanatory diagram for describing another example of the process flow of the system 10.

FIG. 14 schematically illustrates another example of the functional configuration of the information processing apparatus 200.

FIG. 15 is an explanatory diagram for describing another example of the process flow of the system 10.

FIG. 16 is an explanatory diagram for describing another example of the process flow of the system 10.

FIG. 17 is an explanatory diagram for describing another example of the process flow of the system 10.

FIG. 18 is an explanatory diagram for describing another example of the process flow of the system 10.

FIG. 19 is an explanatory diagram for describing another example of the process flow of the system 10.

FIG. 20 schematically illustrates another example of the functional configuration of the information processing apparatus 200.

FIG. 21 schematically illustrates an example of a hardware configuration of a computer 1200 which functions as the information processing apparatus 200.

### DESCRIPTION OF EXEMPLARY EMBODIMENTS

Up to now, when remote operation of a drone is performed by transmitting, to the drone, an operation signal generated based on an operation action input to a proportional system having a cellular communication function in a remote site via a mobile communication network, a pairing relationship between the proportional system and the drone which have the cellular communication function needs to be set in advance. That is, the pairing relationship between the proportional system and the drone which have the cellular communication function cannot be changed while the drone is flying. Accordingly, in a case of operating one drone by switching an operation apparatus having an operation authority over the drone among N proportional systems in total including (N-1) proportional systems having the cellular communication function in the remote site and one general proportional system in a local site which has a special wireless communication function, such as a Wi-Fi (registered trademark) proportional system, used by a pilot in the local site in order to operate the drone when, for example, the drone is positioned in a range where the drone can be seen by the pilot in the local site, it is required to assign the N proportional systems to the above-described drone while the above-described drone is flying, and in a similar configuration, when M drones are required to simultaneously fly, M×N proportional systems are required to be prepared. A system according to one embodiment adopts a scheme in which, for example, a drone management server can control the pairing relationship between the proportional system and the drone which have the cellular communication function while the drone is flying.

Hereinafter, the present invention will be described through embodiments of the invention, but the following embodiments do not limit the invention according to claims. Further, not all of combinations of features described in the embodiments are essential to the solving means of the invention.

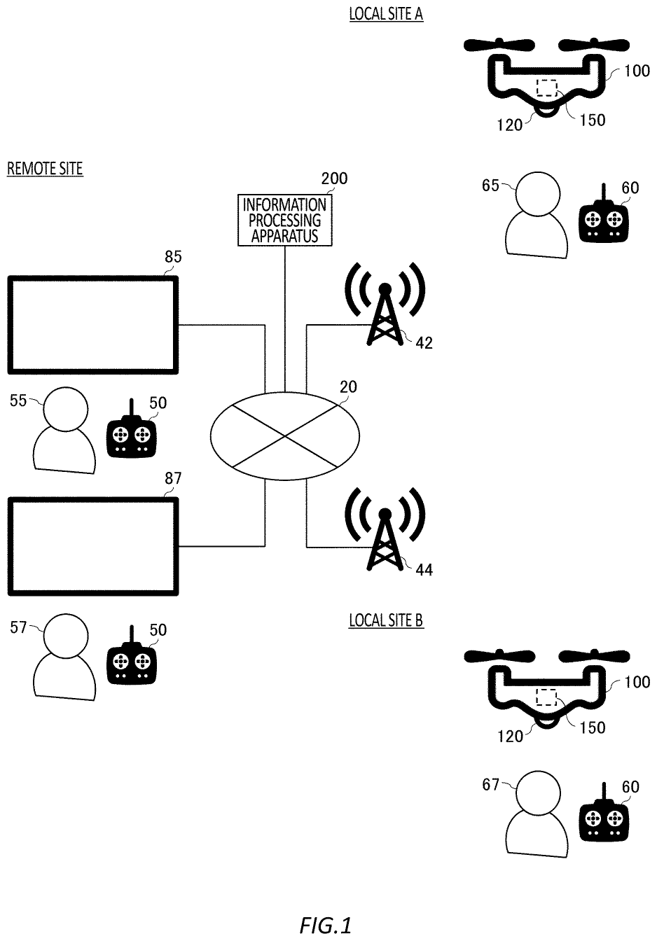

FIG. 1 schematically illustrates an example of a system 10. The system 10 may include, for example, a drone 100. The system 10 may include an operation apparatus 50. The system 10 may include an operation apparatus 60.

The system 10 provides, for example, a missing-person search drone wireless relay service in which the drone 100 wirelessly relays access to a network 20 while searching for a missing person based on a captured image which has been captured by a camera 120 mounted to the drone 100. The system 10 provides, for example, an inspection service for inspecting an inspection target such as a power transmission line, a building, a bridge or a road based on the captured image which has been captured by the camera 120. The system 10 may provide any other services.

The drone 100 may include a control apparatus 150 and a battery which is not illustrated in the drawing. The drone 100 may fly by using electric power accumulated in the battery.

The drone 100 may acquire positional information of the drone 100 by using, for example, a GPS (Global Positioning System) function or the like. The positional information of the drone 100 includes, for example, latitude information indicating latitude of the drone 100. The positional information of the drone 100 includes, for example, longitude information indicating longitude of the drone 100.

The positional information of the drone 100 may include altitude information indicating an altitude of the drone 100. In this case, the positional information of the drone 100 is three-dimensional positional information indicating a three-dimensional position of the drone 100.

The control apparatus 150 controls various types of operations of the drone 100. The control apparatus 150 is composed of, for example, a flight controller (FC) which performs flight control processing of the drone 100, a microcontroller such as a Raspberry Pi which performs computation processing and storage processing of the drone 100, and a communication module which performs communication processing of the drone 100.

The control apparatus 150 controls the flight of the drone 100 such that, for example, the drone 100 flies in a remote operation flight mode. The remote operation flight mode refers to a flight mode in which the drone 100 flies based on an operation signal received via the network 20 from the operation apparatus 50 in a remote site (for example, a remote operation center). The remote operation flight mode may be an example of a manual operation flight mode.

In the example illustrated in FIG. 1, when a flight mode of a drone 100 in a local site A (for example, Tokyo) is the remote operation flight mode, the drone 100 may fly based on an operation signal received via the network 20 and a base station 42 from the operation apparatus 50 of a user 55 in a remote site or the operation apparatus 50 of a user 57 in a remote site. Similarly, when a flight mode of a drone 100 in a local site B (for example, Hokkaido) different from the local site A is the remote operation flight mode, the drone 100 may fly based on an operation signal received via the network 20 and a base station 44 from the operation apparatus 50 of the user 55 in the remote site or the operation apparatus 50 of the user 57 in the remote site.

The network 20 includes a core network provided by a telecommunication carrier, for example. The core network is compliant with a 5G (5th Generation) communication system, for example. The core network may be compliant with a mobile communication system of a 6G (6th Generation) communication system onwards. The core network may be compliant with a 3G (3rd Generation) communication system. The core network may be compliant with an LTE (Long Term Evolution) communication system. The network 20 may include the Internet.

The operation apparatus 50 may be any apparatus as long as an operation signal generated based on an operation action input by the user can be transmitted to the drone 100 via the network 20. The operation apparatus 50 is composed of, for example, a microcontroller such as a Raspberry Pi which performs computation processing and storage processing of the operation apparatus 50, and a communication module which performs wireless communication processing of the operation apparatus 50. The operation apparatus 50 is, for example, a so-called proportional system set of a digital proportional scheme (proportional system set may be abbreviated and described as a proportional system).

The control apparatus 150 controls the flight of the drone 100 such that, for example, the drone 100 flies in a local site operation flight mode. The local site operation flight mode refers to a flight mode in which the drone 100 flies based on an operation signal received from an operation apparatus 60 in a local site via a direct wireless communication connection between the drone 100 and the operation apparatus 60. Direct wireless communication between the drone 100 and the operation apparatus 60 in the local site may be compliant with a short-range wireless communication scheme such as, for example, Wi-Fi, Bluetooth (registered trademark), or ZigBee (registered trademark). The local site operation flight mode may be an example of the manual operation flight mode.

In the example illustrated in FIG. 1, when a flight mode of a drone 100 in the local site A is the local site operation flight mode, the drone 100 may fly based on an operation signal received from an operation apparatus 60 of a user 65 in the local site A via the direct wireless communication connection between the drone 100 and the operation apparatus 60. Similarly, when a flight mode of a drone 100 in the local site B is the local site operation flight mode, the drone 100 may fly based on an operation signal received from an operation apparatus 60 of a user 67 in the local site B via the direct wireless communication connection between the drone 100 and the operation apparatus 60.

The operation apparatus 60 may be any apparatus as long as an operation signal generated based on an operation action input by the user can be transmitted to the drone 100 via the direct wireless communication connection with the drone 100. The operation apparatus 60 is composed of, for example, a microcontroller such as a Raspberry Pi which performs computation processing and storage processing of the operation apparatus 60, and a communication module which performs direct wireless communication processing of the operation apparatus 60. The operation apparatus 60 is, for example, a proportional system.

The control apparatus 150 may control the flight of the drone 100 such that the drone 100 flies in an autonomous flight mode. The autonomous flight mode refers to a flight mode in which the drone 100 carries out autonomous flight. When the flight mode of the drone 100 is the autonomous flight mode, the control apparatus 150 may control the autonomous flight of the drone 100 based on, for example, at least one of a captured image which has been captured by the camera 120 mounted to the drone 100, positional information of the drone 100, or detection information detected by various types of sensors such as a speed sensor, an acceleration sensor, and an angular sensor which are mounted to the drone 100.

The control apparatus 150 may control communication of the drone 100 such that telemetry information of the drone 100 is transmitted to an information processing apparatus 200 via the network 20. The telemetry information includes, for example, positional information of the drone 100. The telemetry information includes, for example, detection information detected by various types of sensors mounted to the drone 100. The detection information includes, for example, flight speed information indicating a flight speed of the drone 100. The detection information includes, for example, acceleration information indicating an acceleration of the drone 100. The detection information includes, for example, flight direction information indicating a flight direction of the drone 100. The detection information may include malfunction information indicating that an airframe of the drone 100 is malfunctioning. The telemetry information may include battery remaining amount information indicating a battery remaining amount of the battery mounted to the drone 100. The control apparatus 150 may control communication of the drone 100 such that a captured image which has been captured by the camera 120 mounted to the drone 100 is transmitted to the information processing apparatus 200 via the network 20.

The information processing apparatus 200 performs various types of processing. The information processing apparatus 200 performs, for example, pairing establishment processing for establishing a pairing between the operation apparatus 50 and the drone 100. The information processing apparatus 200 performs the pairing establishment processing before the drone 100 starts to fly, for example. The information processing apparatus 200 performs the pairing establishment processing while the drone 100 is flying, for example. The information processing apparatus 200 performs the pairing establishment processing by, for example, writing an IP address of the drone 100 to the operation apparatus 50 and writing an IP address of the operation apparatus 50 to the drone 100. As a result of the pairing establishment processing by the information processing apparatus 200, the operation apparatus 50 can transmit an operation signal to the drone 100.

The information processing apparatus 200 performs, for example, flight mode setting processing for setting a flight mode of the drone 100. The information processing apparatus 200 performs, for example, flight mode switch processing for switching the flight mode of the drone 100.

The information processing apparatus 200 performs, for example, operation authority setting processing for setting an operation apparatus 50 which has an operation authority over the drone 100 which flies in the remote operation flight mode. The information processing apparatus 200 performs, for example, operation authority switch processing for switching the operation apparatus 50 which has an operation authority over the drone 100 which flies in the remote operation flight mode. In the example illustrated in FIG. 1, for example, while the drone 100 in the local site A is flying in the remote operation flight mode in the local site A, the information processing apparatus 200 switches the operation apparatus 50 having the operation authority over the drone 100 in the local site A from the operation apparatus 50 of the user 55 to the operation apparatus 50 of the user 57 by transmitting, to the drone 100, an operation authority switch signal indicating switch from a flight based on an operation signal transmitted by the operation apparatus 50 of the user 55 to a flight based on an operation signal transmitted by the operation apparatus 50 of the user 57.

The information processing apparatus 200 performs, for example, operation target switch processing for switching an operation target of the operation apparatus 50. In the example illustrated in FIG. 1, for example, while the operation apparatus 50 of the user 55 is remotely operating the drone 100 in the local site A, the information processing apparatus 200 switches an operation target of the operation apparatus 50 of the user 55 from the drone 100 in the local site A to the drone 100 in the local site B by transmitting, to the drone 100 in the local site A, an end signal indicating end of the flight based on the operation signal transmitted by the operation apparatus 50 of the user 55, and transmitting, to the drone 100 in the local site B, a start signal indicating start of the flight based on the operation signal transmitted by the operation apparatus 50 of the user 55. In the example illustrated in FIG. 1, while the operation apparatus 50 of the user 55 is remotely operating the drone 100 in the local site A, the information processing apparatus 200 may switch the operation target of the operation apparatus 50 of the user 55 from the drone 100 in the local site A to the drone 100 in the local site B by transmitting, to the operation apparatus 50 of the user 55, an operation target switch instruction for instructing the switching of the operation target of the operation apparatus 50 of the user 55 from the drone 100 in the local site A to the drone 100 in the local site B.

The information processing apparatus 200 performs, for example, display control processing for causing a display to display various types of information related to the drone 100. The information processing apparatus 200 performs the display control processing by, for example, causing a display corresponding to the operation apparatus 50 which establishes a pairing with the drone 100 to display various types of information related to the drone 100. The information processing apparatus 200 causes the drone 100 to transmit various types of information to the display via, for example, the network 20.

The information processing apparatus 200 causes the display to display the telemetry information of the drone 100, for example. The information processing apparatus 200 may cause the display to display a captured image which has been captured by the camera 120 mounted to the drone 100.

In the example illustrated in FIG. 1, for example, when each of a pairing between the operation apparatus 50 of the user 55 and the drone 100 in the local site A and a pairing between the operation apparatus 50 of the user 57 and the drone 100 in the local site B is established, the information processing apparatus 200 causes a display 85 corresponding to the operation apparatus 50 of the user 55 to display various types of information related to the drone 100 in the local site A, and causes a display 87 corresponding to the operation apparatus 50 of the user 57 to display various types of information related to the drone 100 in the local site B.

In the example illustrated in FIG. 1, for example, when each of the pairing between the operation apparatus 50 of the user 55 and the drone 100 in the local site A and the pairing between the operation apparatus 50 of the user 55 and the drone 100 in the local site B is established, the information processing apparatus 200 causes the display 85 corresponding to the operation apparatus 50 of the user 55 to display various types of information related to the drone 100 in the local site A and various types of information related to the drone 100 in the local site B. In this case, the information processing apparatus 200 causes a plurality of displays 85 corresponding to the operation apparatus 50 of the user 55 to display various types of information related to the drone 100 in the local site A and various types of information related to the drone 100 in the local site B, for example. The information processing apparatus 200 may cause one display 85 corresponding to the operation apparatus 50 of the user 55 to display various types of information related to the drone 100 in the local site A and various types of information related to the drone 100 in the local site B. When the drone 100 that is set as the operation target of the operation apparatus 50 of the user 55 is the drone 100 in the local site A, the information processing apparatus 200 may cause the display 85 to display various types of information related to the drone 100 in the local site A to be more noticeable.

The information processing apparatus 200 causes the display 85 to display various types of information related to the drone 100 in the local site A to be more noticeable by, for example, displaying information indicating being the drone 100 set as the operation target of the operation apparatus 50 of the user 55 in a vicinity of an area where various types of information related to the drone 100 in the local site A are displayed. The information processing apparatus 200 causes the display 85 to display various types of information related to the drone 100 in the local site A to be more noticeable by, for example, displaying various types of information related to the drone 100 in the local site A in a color different from that of various types of information related to the drone 100 in the local site B. The information processing apparatus 200 may cause the display 85 to display various types of information related to the drone 100 in the local site A to be more noticeable by displaying various types of information related to the drone 100 in the local site A in a size larger than that of various types of information related to the drone 100 in the local site B.

In the example illustrated in FIG. 1, the flight of the drone 100 flying in the manual operation flight mode may be more flexibly controlled than the flight of the drone 100 flying in the autonomous flight mode. In addition, an operation technique of the drone 100 by the user in a remote site may be higher than an operation technique of the drone 100 by the user in a local site. The user in the remote site is, for example, a professional drone pilot. The user in the local site is, for example, an operator. Furthermore, an operation technique of the drone 100 by the user 57 in the remote site may be higher than an operation technique of the drone 100 by the user 55 in the remote site.

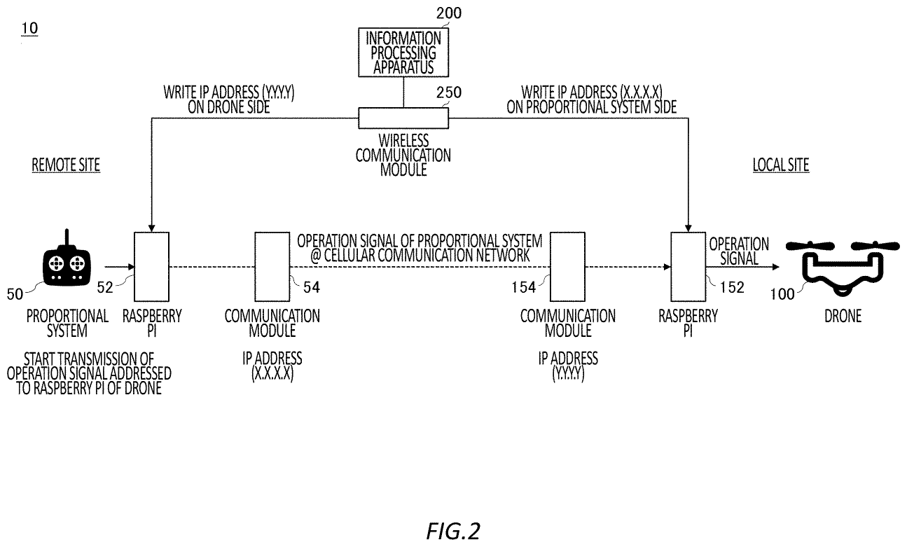

FIG. 2 is a schematic diagram for describing an example of a pairing. Herein, an example of a case where the information processing apparatus 200 establishes a pairing between a proportional system and a drone will be mainly described.

For example, the information processing apparatus 200 writes an IP address (Y.Y.Y.Y) on a drone side to a Raspberry Pi 52 mounted to a proportional system by transmitting, to the proportional system, the IP address (Y.Y.Y.Y) of a communication module 154 mounted to the drone by using a wireless communication module 250. In addition, the information processing apparatus 200 writes an IP address (X.X.X.X) on a proportional system side to a Raspberry Pi 152 mounted to a drone by transmitting, to the drone, the IP address (X.X.X.X) of a communication module 54 mounted to the proportional system by using the wireless communication module 250. As a result, the information processing apparatus 200 establishes the pairing between the proportional system and the drone.

The proportional system may start the transmission of an operation signal addressed to the Raspberry Pi 152 of the drone by using the communication module 54 in response to the establishment of the pairing between the proportional system and the drone. The drone may receive an operation signal of the proportional system via a cellular communication network that is an example of the network 20 by using the communication module 154 and transfer the received operation signal of the proportional system to the Raspberry Pi 152. The Raspberry Pi 152 may transfer the operation signal of the proportional system to an FC mounted to the drone. The FC may control the flight of the drone 100 based on the operation signal transferred by the Raspberry Pi 152.

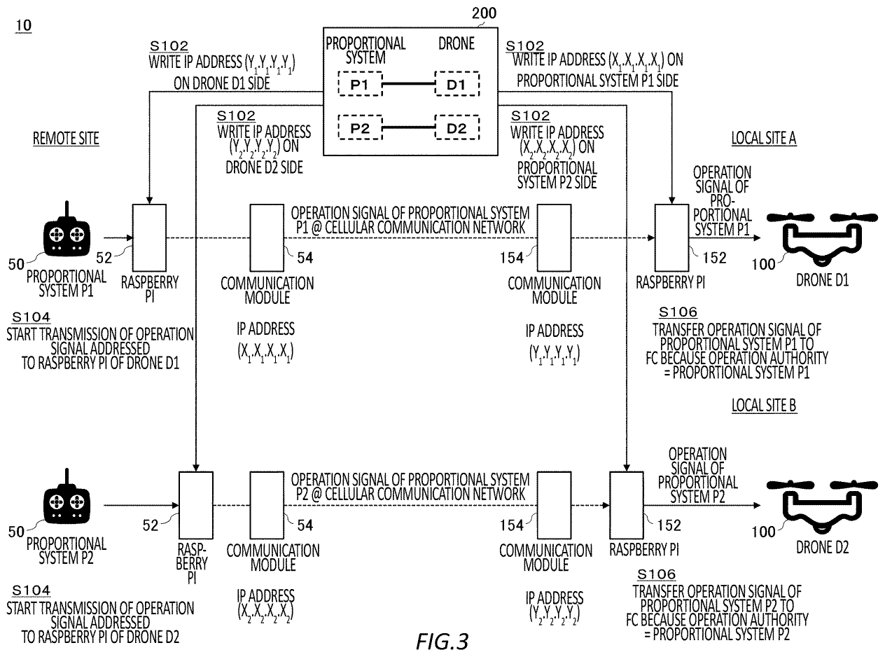

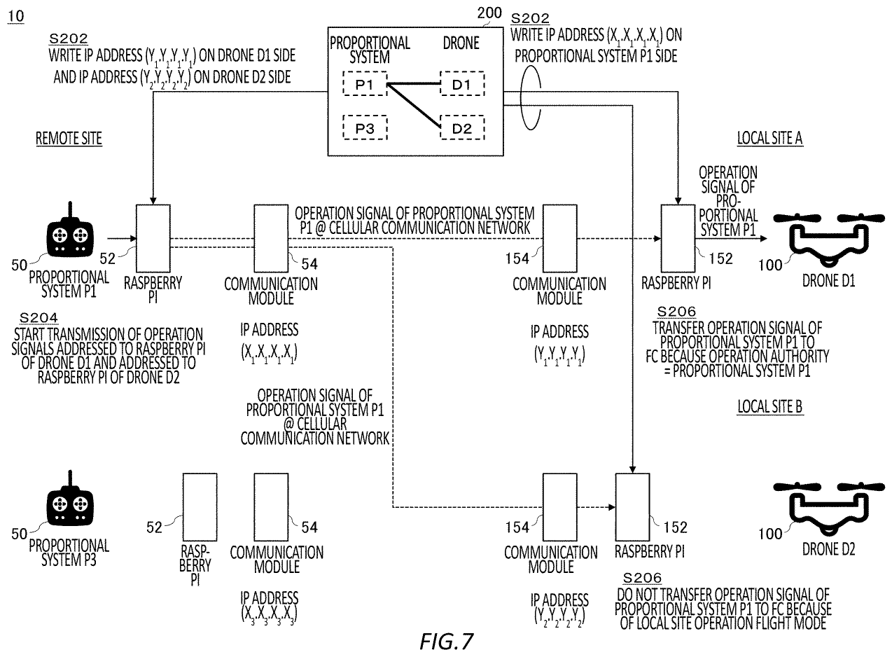

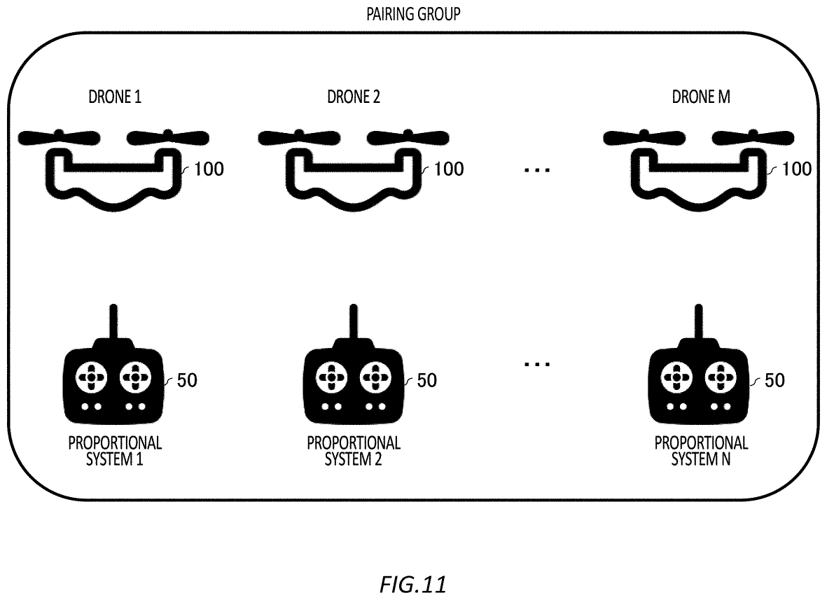

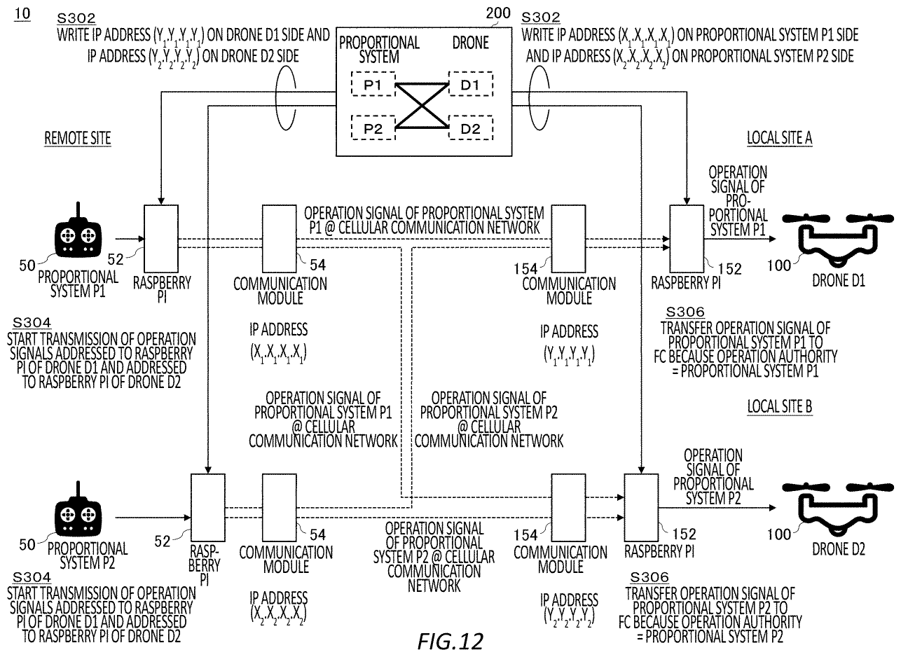

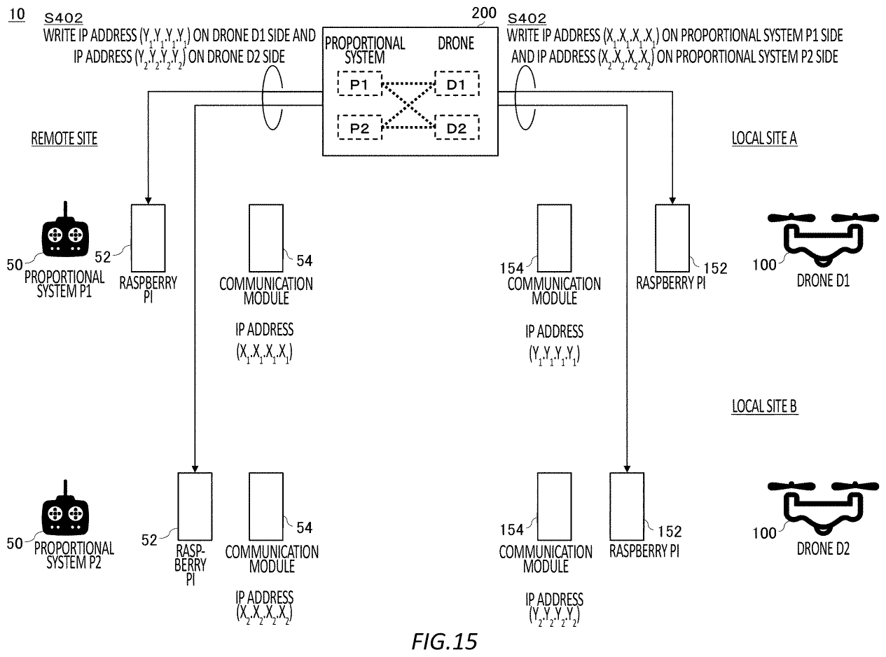

FIG. 3 to FIG. 5 are explanatory diagrams for describing an example of a process flow of the system 10. Herein, a state in which the pairing between the proportional system and the drone is not established and a drone D1 and a drone D2 remain on a ground in the remote operation flight mode will be described as a start state. Note that in FIG. 3 to FIG. 5, FIG. 7 to FIG. 9, FIG. 11, FIG. 12, and FIG. 15 to FIG. 19, a dotted line connecting the proportional system in the information processing apparatus 200 and the drone represents a state in which the pairing between the proportional system and the drone is established, and a solid line connecting the proportional system in the information processing apparatus 200 and the drone represents a state in which the proportional system transmits an operation signal to the drone.

In step (step may be abbreviated and described as S) 102 in FIG. 3, the information processing apparatus 200 establishes a pairing between a proportional system P1 and the drone D1 by writing an IP address (Y₁. Y₁. Y₁. Y₁) on the drone D1 side to the Raspberry Pi 52 mounted to the proportional system P1 and writing an IP address (X₁. X₁. X₁. X₁) on the proportional system P1 side to the Raspberry Pi 152 mounted to the drone D1. The proportional system P1 may transmit an IP address reception response indicating the reception of the IP address on the drone D1 side to the information processing apparatus 200 by using the communication module 54 in response to the writing of the IP address (Y₁. Y₁. Y₁. Y₁) on the drone D1 side by the information processing apparatus 200. The drone D1 may transmit an IP address reception response indicating the reception of the IP address on the proportional system P1 side to the information processing apparatus 200 by using the communication module 154 in response to the writing of the IP address (X₁. X₁. X₁. X₁) on the proportional system P1 side by the information processing apparatus 200.

In addition, in S102, the information processing apparatus 200 establishes a pairing between a proportional system P2 and the drone D2 by writing an IP address (Y₂. Y₂. Y₂. Y₂) on the drone D2 side to the Raspberry Pi 52 mounted to the proportional system P2 and writing an IP address (X₂. X₂. X₂. X₂) on the proportional system P2 side to the Raspberry Pi 152 mounted to the drone D2. Similarly as in the proportional system P1, the proportional system P2 may transmit an IP address reception response indicating the reception of the IP address on the drone D2 side to the information processing apparatus 200. Similarly as in the drone D1, the drone D2 may transmit an IP address reception response indicating the reception of the IP address on the proportional system P2 side to the information processing apparatus 200.

In S104, the proportional system P1 starts the transmission of an operation signal addressed to the Raspberry Pi 152 of the drone D1 by using the communication module 54. The proportional system P1 starts the transmission of the operation signal addressed to the Raspberry Pi 152 of the drone D1 in response to, for example, the writing of the IP address (Y₁. Y₁. Y₁. Y₁) on the drone D1 side by the information processing apparatus 200 in S102. The proportional system P1 may start the transmission of the operation signal addressed to the Raspberry Pi 152 of the drone D1 in response to the information processing apparatus 200 having been instructed to start the transmission of the operation signal to the drone D1. The drone D1 receives the operation signal of the proportional system P1 via the cellular communication network by using the communication module 154, and transfers the received operation signal of the proportional system P1 to the Raspberry Pi 152. Herein, the description will continue while it is assumed that the operation apparatus 50 having the operation authority over the drone D1 in the remote operation flight mode is set to the proportional system P1.

In addition, in S104, similarly as in the proportional system P1, the proportional system P2 starts the transmission of the operation signal addressed to the Raspberry Pi 152 of the drone D2 by using the communication module 54. The drone D2 receives the operation signal of the proportional system P2 via the cellular communication network by using the communication module 154, and transfers the received operation signal of the proportional system P2 to the Raspberry Pi 152. Herein, the description will continue while it is assumed that the operation apparatus 50 having the operation authority over the drone D2 in the remote operation flight mode is set to the proportional system P2.

In S106, the Raspberry Pi 152 of the drone D1 transfers the operation signal of the proportional system P1 to the FC of the drone D1 because the flight mode of the drone D1 is set to the remote operation flight mode and the operation apparatus 50 having the operation authority over the drone D1 is set to the proportional system P1. The FC of the drone D1 starts the flight of the drone D1 based on the operation signal of the proportional system P1 which has been transferred by the Raspberry Pi 152.

In addition, in S106, the Raspberry Pi 152 of the drone D2 transfers the operation signal of the proportional system P2 to the FC of the drone D2 because the flight mode of the drone D2 is set to the remote operation flight mode and the operation apparatus 50 having the operation authority over the drone D2 is set to the proportional system P2. The FC of the drone D2 starts the flight of the drone D2 based on the operation signal of the proportional system P2 which has been transferred by the Raspberry Pi 152.

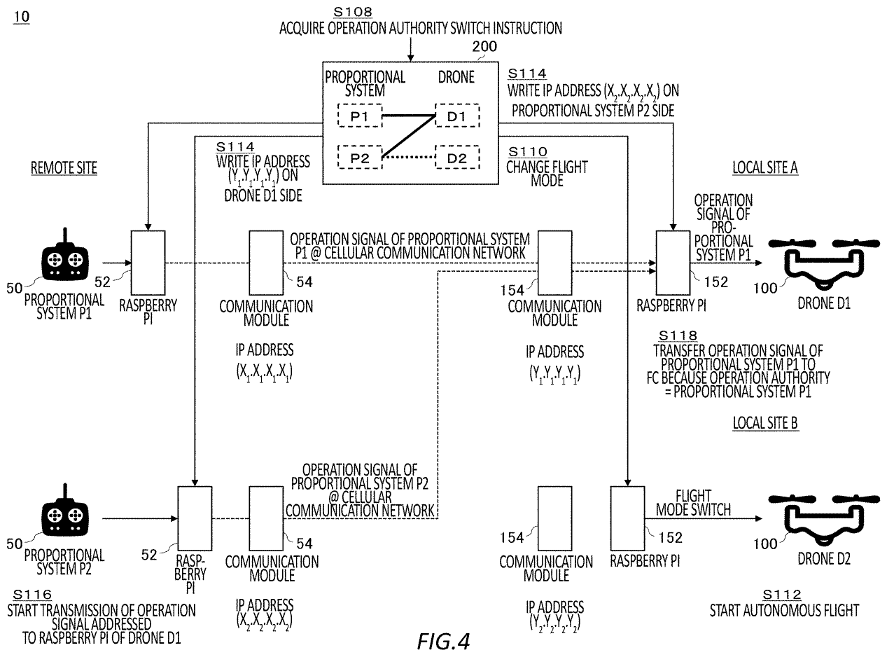

In S108 of FIG. 4, the information processing apparatus 200 acquires an operation authority switch instruction for instructing the switching of the operation apparatus 50 having the operation authority over the drone D1 from the proportional system P1 to the proportional system P2. In S110, in response to the acquisition of the operation authority switch instruction in S108, the information processing apparatus 200 changes the flight mode of the drone D2 which is stored in the Raspberry Pi 152 of the drone D2 from the remote operation flight mode to the autonomous flight mode by transmitting, to the drone D2, a flight mode switch signal indicating the switching of the flight mode of the drone D2 from the remote operation flight mode to the autonomous flight mode.

In S112, the FC of the drone D2 causes the drone D2 to start autonomous flight in response to the change in the flight mode of the drone D2 which is stored in the Raspberry Pi 152 of the drone D2 from the remote operation flight mode to the autonomous flight mode by the information processing apparatus 200 in S110. In response to the start of the autonomous flight, the drone D2 may transmit, to the information processing apparatus 200, a flight mode switch response indicating the switching of the flight mode of the drone D2 from the remote operation flight mode to the autonomous flight mode by using the communication module 154. The information processing apparatus 200 may instruct the proportional system P2 to end the transmission of the operation signal to the drone D2 in response to the reception of the flight mode switch response from the drone D2. The proportional system P2 may end the transmission of the operation signal to the drone D2 according to an instruction by the information processing apparatus 200.

In S114, in response to the end of the transmission of the operation signal to the drone D2 by the proportional system P2, the information processing apparatus 200 establishes a pairing between the proportional system P2 and the drone D1 by writing the IP address (Y₁. Y₁. Y₁. Y₁) on the drone D1 side to the Raspberry Pi 52 mounted to the proportional system P2 and writing the IP address (X₂. X₂. X₂. X₂) on the proportional system P2 side to the Raspberry Pi 152 mounted to the drone D1. The proportional system P2 may transmit, to the information processing apparatus 200, the IP address reception response indicating the reception of the IP address on the drone D1 side by using the communication module 54 in response to the writing of the IP address (Y₁. Y₁. Y₁. Y₁) on the drone D1 side by the information processing apparatus 200. The drone D1 may transmit, to the information processing apparatus 200, the IP address reception response indicating the reception of the IP address on the proportional system P2 side by using the communication module 154 in response to the writing of the IP address (X₂. X₂. X₂. X₂) on the proportional system P2 side by the information processing apparatus 200.

In S116, the proportional system P2 starts the transmission of the operation signal addressed to the Raspberry Pi 152 of the drone D1 by using the communication module 54. The proportional system P2 starts the transmission of the operation signal addressed to the Raspberry Pi 152 of the drone D1 in response to, for example, the writing of the IP address (Y₁. Y₁. Y₁. Y₁) on the drone D1 side by the information processing apparatus 200 in S114. The proportional system P2 may start the transmission of the operation signal addressed to the Raspberry Pi 152 of the drone D1 in response to the information processing apparatus 200 having been instructed to start the transmission of the operation signal to the drone D1. The drone D1 receives the operation signal of the proportional system P2 via the cellular communication network by using the communication module 154, and transfers the received operation signal of the proportional system P2 to the Raspberry Pi 152.

In S118, the Raspberry Pi 152 of the drone D1 transfers the operation signal of the proportional system P1 to the FC of the drone D1 and does not transfer the operation signal of the proportional system P2 to the FC of the drone D1 because the flight mode of the drone D1 is set to the remote operation flight mode and the operation apparatus 50 having the operation authority over the drone D1 is set to the proportional system P1. The FC of the drone D1 controls the flight of the drone D1 based on the operation signal of the proportional system P1 which has been transferred by the Raspberry Pi 152.

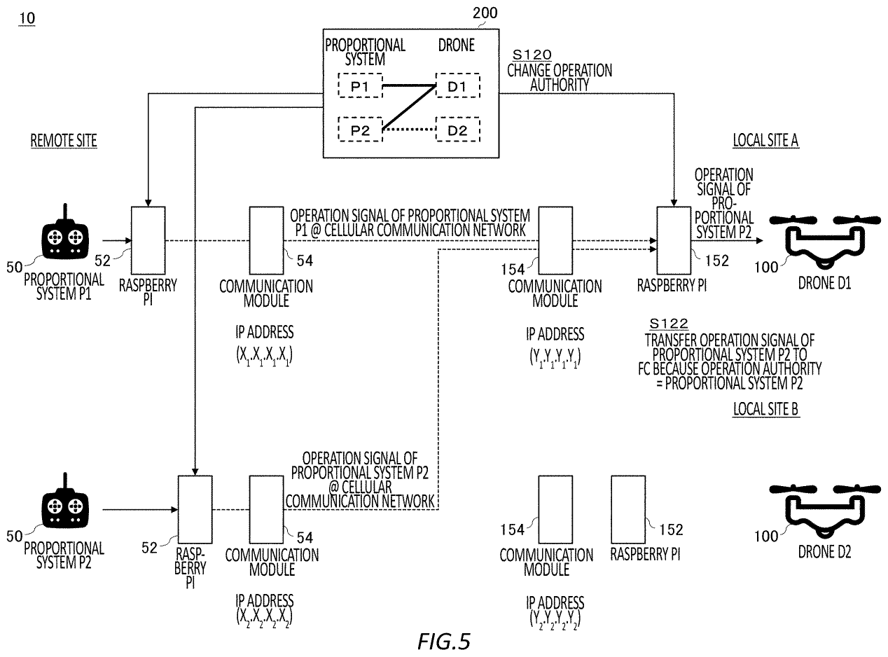

In S120 of FIG. 5, the information processing apparatus 200 changes the operation apparatus 50 having the operation authority over the drone D1 which is stored in the Raspberry Pi 152 of the drone D1 from the proportional system P1 to the proportional system P2 by transmitting, to the drone D1, the operation authority switch signal indicating the switch from the flight based on the operation signal transmitted by the proportional system P1 to the flight based on the operation signal transmitted by the proportional system P2. In S122, the Raspberry Pi 152 of the drone D1 ends the transfer of the operation signal of the proportional system P1 to the FC of the drone D1 and starts the transfer of the operation signal of the proportional system P2 to the FC of the drone D1 in response to the change in the operation apparatus 50 having the operation authority over the drone D1 in S120 from the proportional system P1 to the proportional system P2 by the information processing apparatus 200. The FC of the drone D1 controls the flight of the drone D1 based on the operation signal of the proportional system P2 which has been transferred by the Raspberry Pi 152. As a result, the operation authority switch processing for switching the operation apparatus 50 having the operation authority over the drone D1 from the proportional system P1 to the proportional system P2 by the information processing apparatus 200 is completed.

In response to the start of the flight based on the operation signal transmitted by the proportional system P2, the drone D1 may transmit, to the information processing apparatus 200, an operation authority switch response indicating the switching of the operation apparatus 50 having the operation authority over the drone D1 from the proportional system P1 to the proportional system P2 by using the communication module 154. In response to the reception of the operation authority switch response from the drone D1, the information processing apparatus 200 may instruct the proportional system P1 to end the transmission of the operation signal to the drone D1. The proportional system P1 may end the transmission of the operation signal to the drone D1 according to an instruction by the information processing apparatus 200.

The processing in S108 and S110 of FIG. 4 may be changed to processing for directly transmitting, to the drone D2, the flight mode switch signal indicating the switching of the flight mode of the drone D2 from the remote operation flight mode to the autonomous flight mode by the proportional system P2 having the operation authority over the drone D2 in the remote operation flight mode. As a result, the flight mode of the drone can be switched without intermediation of the information processing apparatus 200. In this case, when necessary, the information processing apparatus 200 may switch the operation apparatus 50 having the operation authority over the drone D1 from the proportional system P1 to the proportional system P2.

A conventional system which remotely operates a drone via a mobile communication network by using an operation apparatus reuses a configuration of a system which operates the drone via direct wireless communication between the operation apparatus and the drone by using the operation apparatus. Accordingly, when the drone is remotely operated in the conventional system, a pairing between the operation apparatus and the drone needs to be set in advance, and a pilot of the drone cannot be switched while the drone is flying.

On the other hand, when the drone is operated by using the operation apparatus, the pilot of the drone may be requested to have an advanced operation technique. In particular, when a drone is used for the missing-person search drone wireless relay service or an inspection service, because the drone is a relatively large drone, the pilot of the drone requires a more advanced operation technique. In addition, an operation difficulty of the drone varies depending on a flight situation in which the drone flies. Since the operation technique of the drone varies depending on a drone pilot, by switching the drone pilot flexibly and efficiently while the drone is flying, a drone pilot having a more advanced operation technique is desirably responsible for operating the drone in a flight situation with a higher operation difficulty.

In accordance with the system 10 illustrated in FIG. 3 to FIG. 5, while the drone 100 is flying in the remote operation flight mode, by transmitting the IP address of the drone 100 to an operation apparatus 50 at a switching destination and transmitting an IP address of the operation apparatus 50 at the switching destination to the drone 100 to establish a pairing between the operation apparatus 50 at the switching destination and the drone 100, the information processing apparatus 200 switches the operation apparatus 50 having the operation authority over the drone 100. As a result, without regularly assigning a plurality of operation apparatuses 50 to a drone 100 while the drone 100 is flying, by switching the operation apparatus 50 having the operation authority over the drone 100 among the plurality of operation apparatuses 50, the one drone 100 can be remotely operated. Accordingly, in the system 10 illustrated in FIG. 3 to FIG. 5, because the information processing apparatus 200 can flexibly and efficiently switch the pilot of the drone 100 while the drone 100 is flying, a configuration can be achieved in which a drone pilot having a more advanced operation technique becomes responsible for operating the drone in a flight situation with a higher operation difficulty.

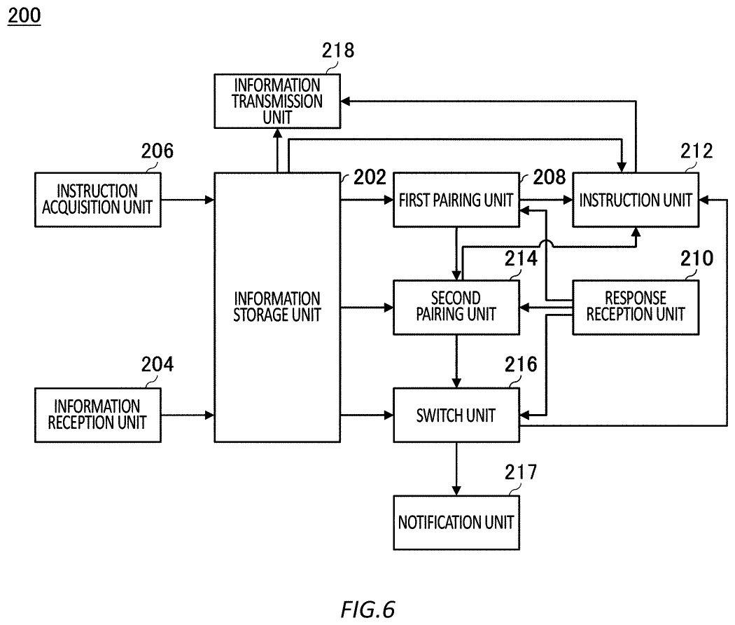

FIG. 6 schematically illustrates an example of a functional configuration of the information processing apparatus 200. The information processing apparatus 200 includes an information storage unit 202, an information reception unit 204, an instruction acquisition unit 206, a first pairing unit 208, a response reception unit 210, an instruction unit 212, a second pairing unit 214, a switch unit 216, a notification unit 217, and an information transmission unit 218. Note that it is not necessarily required for the information processing apparatus 200 to include all of these components.

The information storage unit 202 stores various types of information. The information storage unit 202 stores, for example, an IP address of the drone 100. The information storage unit 202 stores, for example, an IP address of the operation apparatus 50.

The information storage unit 202 may store pairing relationship information indicating a pairing relationship between the operation apparatus 50 and the drone 100. A pairing relationship between the operation apparatus 50 and the drone 100 indicates, for example, that a pairing between the operation apparatus 50 and the drone 100 is established. The pairing relationship between the operation apparatus 50 and the drone 100 indicates, for example, that a pairing between the operation apparatus 50 and the drone 100 is not established.

The information reception unit 204 receives various types of information related to the drone 100 from the drone 100. For example, the information reception unit 204 periodically receives various types of information related to the drone 100. The information reception unit 204 may store various types of received information related to the drone 100 in the information storage unit 202.

The information reception unit 204 receives, for example, telemetry information of the drone 100. The information reception unit 204 may receive a captured image which has been captured by the camera 120 mounted to the drone 100.

The instruction acquisition unit 206 acquires various types of instructions. The instruction acquisition unit 206 acquires various types of instructions by, for example, receiving various types of instructions from a communication terminal. The communication terminal is, for example, a communication terminal of a user who locally operates the drone 100. The communication terminal is, for example, a communication terminal of a user who remotely operates the drone 100. The communication terminal may be a communication terminal of a user of the information processing apparatus 200. The instruction acquisition unit 206 may acquire various types of instructions when inputs of various types of instructions are accepted by an input unit included in the information processing apparatus 200. The instruction acquisition unit 206 may store various types of acquired instructions in the information storage unit 202.

The instruction acquisition unit 206 acquires a pairing establishment instruction for instructing the establishment of the pairing between the operation apparatus 50 and the drone 100, for example. The instruction acquisition unit 206 acquires a flight mode setting instruction for instructing the setting of a flight mode of the drone 100, for example. The instruction acquisition unit 206 acquires a flight mode switch instruction for instructing the switching of the flight mode of the drone 100, for example. The instruction acquisition unit 206 acquires an operation authority setting instruction for instructing the setting of the operation apparatus 50 having the operation authority over the drone 100 which flies in the remote operation flight mode, for example. The instruction acquisition unit 206 acquires an operation authority switch instruction for instructing the switching of the operation apparatus 50 having the operation authority over the drone 100 which flies in the remote operation flight mode, for example.

The first pairing unit 208 establishes a first pairing between a first operation apparatus and the drone 100. The operation apparatus 50 may be an example of the first operation apparatus.

The first pairing unit 208 establishes the first pairing between the first operation apparatus and the drone 100 in response to the acquisition of the pairing establishment instruction by the instruction acquisition unit 206, for example. The first pairing unit 208 establishes the first pairing between the first operation apparatus and the drone 100 by transmitting, for example, the IP address of the drone 100 which is stored in the information storage unit 202 to the first operation apparatus, and transmitting the IP address of the first operation apparatus which is stored in the information storage unit 202 to the drone 100.

The response reception unit 210 receives various types of responses. The response reception unit 210 receives an IP address reception response indicating the reception of the IP address of the drone 100 from the operation apparatus 50, for example. The response reception unit 210 receives an IP address reception response indicating the reception of the IP address of the operation apparatus 50 from the drone 100, for example.

When, for example, the response reception unit 210 receives the IP address reception responses from both the first operation apparatus and the drone 100, the first pairing unit 208 determines that the first pairing between the first operation apparatus and the drone 100 is established. When a predetermined period has elapsed after the IP addresses are respectively transmitted to the first operation apparatus and the drone 100, the first pairing unit 208 may determine that the first pairing between the first operation apparatus and the drone 100 is established.

The instruction unit 212 issues an instruction to perform various types of operations. The instruction unit 212 instructs the operation apparatus 50 to perform various types of operations, for example. For example, in response to the establishment of the first pairing between the first operation apparatus and the drone 100 by the first pairing unit 208, the instruction unit 212 instructs the first operation apparatus to start the transmission of the operation signal to the drone 100.

The instruction unit 212 instructs the drone 100 to perform various types of operations, for example. The instruction unit 212 instructs the drone 100 to set a flight mode of the drone 100 as the flight mode of the drone 100 which is indicated by the flight mode setting instruction acquired by the instruction acquisition unit 206, for example. The instruction unit 212 instructs the drone 100 to set the operation apparatus 50 indicated by the operation authority setting instruction acquired by the instruction acquisition unit 206 as the operation apparatus 50 having the operation authority over the drone 100 which flies in the remote operation flight mode, for example.

The second pairing unit 214 establishes a second pairing between a second operation apparatus that is different from the first operation apparatus and the drone 100. The operation apparatus 50 may be an example of the second operation apparatus.

The second pairing unit 214 establishes the second pairing between the second operation apparatus and the drone 100 in response to, for example, the instruction acquisition unit 206 having acquired the operation authority switch instruction for instructing the switching of the operation apparatus 50 having the operation authority over the drone 100 from the first operation apparatus to the second operation apparatus. For example, while the drone 100 is flying, the second pairing unit 214 establishes the second pairing between the second operation apparatus and the drone 100 by transmitting the IP address of the drone 100 which is stored in the information storage unit 202 to the second operation apparatus, and transmitting the IP address of the second operation apparatus which is stored in the information storage unit 202 to the drone 100.

When, for example, the response reception unit 210 receives the IP address reception responses from both the second operation apparatus and the drone 100, the second pairing unit 214 determines that the second pairing between the second operation apparatus and the drone 100 is established. When a predetermined period has elapsed after the IP addresses are respectively transmitted to the second operation apparatus and the drone 100, the second pairing unit 214 may determine that the second pairing between the second operation apparatus and the drone 100 is established. For example, in response to the establishment of the second pairing between the second operation apparatus and the drone 100 by the second pairing unit 214, the instruction unit 212 instructs the second operation apparatus to start the transmission of the operation signal to the drone 100.

The switch unit 216 performs various types of switch processing. The switch unit 216 performs the flight mode switch processing of the drone 100, for example. For example, in response to the acquisition of the flight mode switch instruction by the instruction acquisition unit 206, the switch unit 216 performs the flight mode switch processing of the drone 100 by transmitting the flight mode switch signal to the drone 100. While the drone 100 is flying, for example, the switch unit 216 transmits the flight mode switch signal to the drone 100.

The response reception unit 210 receives the flight mode switch response from the drone 100, for example. When the flight mode switch response indicating the switch from the remote operation flight mode to another flight mode is received, for example, the instruction unit 212 may instruct the operation apparatus 50 to end the transmission of the operation signal to the drone 100.

The switch unit 216 performs the operation authority switch processing of the drone 100, for example. For example, in response to the establishment of the second pairing between the second operation apparatus and the drone 100 by the second pairing unit 214, the switch unit 216 switches the operation apparatus 50 having the operation authority over the drone 100 from the first operation apparatus to the second operation apparatus by transmitting, to the drone 100, the operation authority switch signal indicating the switch from the flight based on the operation signal transmitted by the first operation apparatus to the flight based on the operation signal transmitted by the second operation apparatus.

The response reception unit 210 may receive the operation authority switch response from the drone 100. In response to the reception of the operation authority switch response from the drone 100, the instruction unit 212 may instruct the drone 100 prior to the switch to end the transmission of the operation signal to the drone 100.

The notification unit 217 provides various types of notifications. For example, the notification unit 217 informs an operation apparatus of various types of notifications. The notification unit 217 may inform a communication terminal of a user of the operation apparatus of various types of notifications.

The notification unit 217 provides various types of notifications by way of image data, for example. The notification unit 217 provides various types of notifications by way of text data, for example. The notification unit 217 may provide various types of notifications by way of audio data.

The notification unit 217 provides, for example, an operation authority switch notification indicating the switching of the operation apparatus 50 having the operation authority over the drone 100 from the first operation apparatus to the second operation apparatus. The notification unit 217 provides the operation authority switch notification before the switching of the operation apparatus 50 having the operation authority over the drone 100 from the first operation apparatus to the second operation apparatus by the switch unit 216, for example.

The notification unit 217 informs, for example, the user of the first operation apparatus of the operation authority switch notification. The notification unit 217 informs, for example, the user of the second operation apparatus of the operation authority switch notification.

When the response reception unit 210 receives a notification acknowledgement response indicating the acknowledgement of the operation authority switch notification from the second operation apparatus or the communication terminal of the user of the second operation apparatus, the switch unit 216 may switch the operation apparatus 50 having the operation authority over the drone 100 from the first operation apparatus to the second operation apparatus. When the response reception unit 210 receives the notification acknowledgement responses from the first operation apparatus or the communication terminal of the user of the first operation apparatus and the second operation apparatus or the communication terminal of the user of the second operation apparatus, the switch unit 216 may switch the operation apparatus 50 having the operation authority over the drone 100 from the first operation apparatus to the second operation apparatus.

The information transmission unit 218 transmits various types of information stored in the information storage unit 202. The information transmission unit 218 periodically transmits various types of information, for example.

The information transmission unit 218 transmits various types of information to, for example, a display. The information transmission unit 218 may transmit various types of information to any other peripheral apparatus of the display.

The information transmission unit 218 transmits the pairing relationship information in order to display the pairing relationship information on a display corresponding to the operation apparatus 50, for example. The information transmission unit 218 transmits the pairing relationship information at a timing, for example, at which a pairing relationship between the operation apparatus 50 and the drone 100 is updated.

The information transmission unit 218 transmits the telemetry information of the drone 100 in order to display the telemetry information on a display corresponding to the operation apparatus 50 which establishes the pairing with the drone 100, for example. The information transmission unit 218 transmits the telemetry information in order to display the telemetry information on a display corresponding to the operation apparatus 50 which transmits the operation signal to the drone 100 among the operation apparatuses 50 which establish the pairing with the drone 100, for example.

In order to display a captured image which has been captured by the camera 120 mounted to the drone 100 on the display corresponding to the operation apparatus 50 which establishes the pairing with the drone 100, the information transmission unit 218 may transmit the captured image. In order to display a captured image which has been captured by the camera 120 mounted to the drone 100 on the display corresponding to the operation apparatus 50 which transmits the operation signal to the drone 100 among the operation apparatuses 50 which establish the pairing with the drone 100, the information transmission unit 218 may transmit the captured image.

FIG. 7 to FIG. 9 are explanatory diagrams for describing another example of the process flow of the system 10. Herein, a description will be provided where a state in which a pairing between the proportional system and the drone is not established, the drone D1 remains on the ground in the remote operation flight mode, and the drone D2 is flying in the local site operation flight mode is set as a start state.

In S202 of FIG. 7, the information processing apparatus 200 establishes each of a pairing between the proportional system P1 and the drone D1 and a pairing between the proportional system P1 and the drone D2 by writing the IP address (Y₁. Y₁. Y₁. Y₁) on the drone D1 side and the IP address (Y₂. Y₂. Y₂. Y₂) on the drone D2 side to the Raspberry Pi 52 mounted to the proportional system P1 and writing the IP address (X₁. X₁. X₁. X₁) on the proportional system P1 side to the Raspberry Pi 152 mounted to the drone D1 and the Raspberry Pi 152 mounted to the drone D2.

The proportional system P1 may transmit, to the information processing apparatus 200, the IP address reception response indicating the reception of the IP address on the drone D1 side and the IP address on the drone D2 side by using the communication module 54 in response to the writing of the IP address (Y₁. Y₁. Y₁. Y₁) on the drone D1 side and the IP address (Y₂. Y₂. Y₂. Y₂) on the drone D2 side by the information processing apparatus 200. Each of the drone D1 and the drone D2 may transmit, to the information processing apparatus 200, the IP address reception response indicating the reception of the IP address on the proportional system P1 side by using the communication module 154 in response to the writing of the IP address (X₁. X₁. X₁. X₁) on the proportional system P1 side by the information processing apparatus 200.

In S204, the proportional system P1 starts the transmission of operation signals which are addressed to the Raspberry Pi 152 of the drone D1 and addressed to the Raspberry Pi 152 of the drone D2 by using the communication module 54. The proportional system P1 starts the transmission of the operation signals which are addressed to the Raspberry Pi 152 of the drone D1 and addressed to the Raspberry Pi 152 of the drone D2, for example, in response to the writing of the IP address (Y₁. Y₁. Y₁. Y₁) on the drone D1 side and the IP address (Y₂. Y₂. Y₂. Y₂) on the drone D2 side by the information processing apparatus 200 in S202. The proportional system P1 may start the transmission of the operation signals which are addressed to the Raspberry Pi 152 of the drone D1 and addressed to the Raspberry Pi 152 of the drone D2 in response to the information processing apparatus 200 having been instructed to start the transmission of the operation signals to the drone D1 and the drone D2.

The drone D1 receives the operation signal of the proportional system P1 via the cellular communication network by using the communication module 154 and transfers the received operation signal of the proportional system P1 to the Raspberry Pi 152. Herein, the description will continue while it is assumed that the operation apparatus 50 having the operation authority over the drone D1 in the remote operation flight mode is set to the proportional system P1. In addition, the drone D2 receives the operation signal of the proportional system P1 via the cellular communication network by using the communication module 154 and transfers the received operation signal of the proportional system P2 to the Raspberry Pi 152.

In S206, the Raspberry Pi 152 of the drone D1 transfers the operation signal of the proportional system P1 to the FC of the drone D1 because the flight mode of the drone D1 is set to the remote operation flight mode and the operation apparatus 50 having the operation authority over the drone D1 is set to the proportional system P1. The FC of the drone D1 starts the flight of the drone D1 based on the operation signal of the proportional system P1 which has been transferred by the Raspberry Pi 152.

In addition, in S206, the Raspberry Pi 152 of the drone D2 does not transfer the operation signal of the proportional system P1 to the FC of the drone D2 because the flight mode of the drone D2 is set to the local site operation flight mode. The FC of the drone D2 controls the flight of the drone D2 based on the operation signal received via the direct wireless communication from the proportional system in the local site.

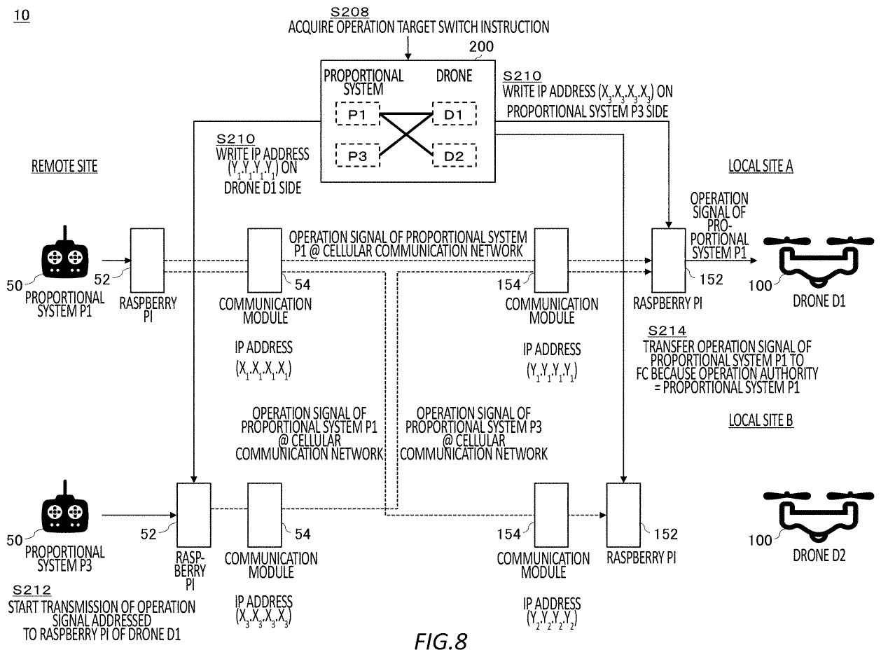

In S208 of FIG. 8, the information processing apparatus 200 acquires the operation target switch instruction for instructing the switching of the operation target of the proportional system P1 from the drone D1 to the drone D2. In response to the acquisition of the operation target switch instruction in S208, the information processing apparatus 200 establishes, in S210, a pairing between a proportional system P3 and the drone D1 by writing the IP address (Y₁. Y₁. Y₁. Y₁) on the drone D1 side to the Raspberry Pi 52 mounted to the proportional system P3 and writing an IP address (X₃. X₃. X₃. X₃) on the proportional system P3 side to the Raspberry Pi 152 mounted to the drone D1.

In S212, the proportional system P3 starts the transmission of the operation signal addressed to the Raspberry Pi 152 of the drone D1 by using the communication module 54. The drone D1 receives the operation signal of the proportional system P3 via the cellular communication network by using the communication module 154, and transfers the received operation signal of the proportional system P3 to the Raspberry Pi 152.

In S214, the Raspberry Pi 152 of the drone D1 transfers the operation signal of the proportional system P1 to the FC of the drone D1 and does not transfer the operation signal of the proportional system P3 to the FC of the drone D1 because the flight mode of the drone D1 is set to the remote operation flight mode and the operation apparatus 50 having the operation authority over the drone D1 is set to the proportional system P1. The FC of the drone D1 controls the flight of the drone D1 based on the operation signal of the proportional system P1 which has been transferred by the Raspberry Pi 152.

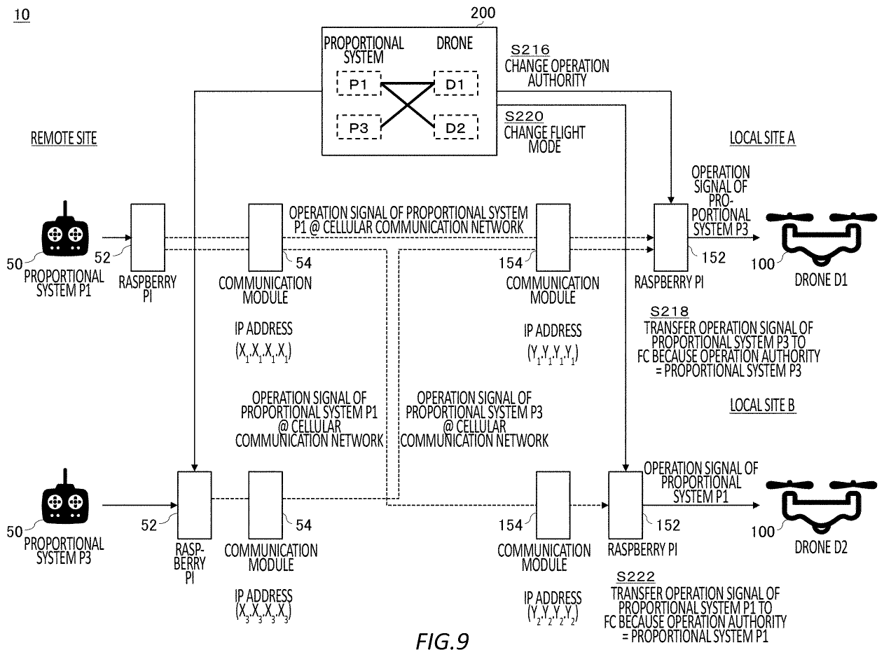

In S216 of FIG. 9, the information processing apparatus 200 changes the operation apparatus 50 having the operation authority over the drone D1 which is stored in the Raspberry Pi 152 of the drone D1 from the proportional system P1 to the proportional system P3 by transmitting, to the drone D1, the operation authority switch signal which includes the end signal indicating the end of the flight based on the operation signal transmitted by the proportional system P1 and the start signal indicating the start of the flight based on the operation signal transmitted by the proportional system P3. In S218, the Raspberry Pi 152 of the drone D1 ends the transfer of the operation signal of the proportional system P1 to the FC of the drone D1 and starts the transfer of the operation signal of the proportional system P3 to the FC of the drone D1 in response to the change in the operation apparatus 50 having the operation authority over the drone D1 in S216 by the information processing apparatus 200 from the proportional system P1 to the proportional system P3. The FC of the drone D1 controls the flight of the drone D1 based on the operation signal of the proportional system P3 which has been transferred by the Raspberry Pi 152. As a result, the operation target switch processing by the information processing apparatus 200 to switch the operation target of the proportional system P1 from the drone D1 to the drone D2 is completed.

In S220, the information processing apparatus 200 changes the flight mode of the drone D2 which is stored in the Raspberry Pi 152 of the drone D2 from the local site operation flight mode to the remote operation flight mode by transmitting, to the drone D2, the flight mode switch signal indicating the switching of the flight mode of the drone D2 from the local site operation flight mode to the remote operation flight mode. The flight mode switch signal includes, for example, the start signal indicating the start of the flight based on the operation signal transmitted by the proportional system P1. In this case, the information processing apparatus 200 writes information indicating that the operation apparatus 50 having the operation authority over the drone D2 is the proportional system P1 to the Raspberry Pi 152 of the drone D2.

In S222, the Raspberry Pi 152 of the drone D2 transfers the operation signal of the proportional system P1 to the FC of the drone D2 because the flight mode of the drone D2 is set to the remote operation flight mode and the operation apparatus 50 having the operation authority over the drone D2 is set to the proportional system P1. The FC of the drone D2 controls the flight of the drone D2 based on the operation signal of the proportional system P1 which has been transferred by the Raspberry Pi 152. As a result, the flight mode switch processing to switch the flight mode of the drone D2 by the information processing apparatus 200 from the local site operation flight mode to the remote operation flight mode is completed.

In response to the start of the flight based on the operation signal transmitted by the proportional system P3, the drone D1 may transmit, to the information processing apparatus 200, the operation authority switch response indicating the switching of the operation apparatus 50 having the operation authority over the drone D1 from the proportional system P1 to the proportional system P3 by using the communication module 154. In response to the start of the flight based on the operation signal transmitted by the proportional system P1, the drone D2 may transmit, to the information processing apparatus 200, the flight mode switch response indicating the switching of the flight mode of the drone D2 from the local site operation flight mode to the remote operation flight mode by using the communication module 154.

In response to the reception of the operation authority switch response from the drone D1 and the reception of the flight mode switch response from the drone D2, the information processing apparatus 200 may instruct the proportional system P1 to end the transmission of the operation signal to the drone D1. The proportional system P1 may end the transmission of the operation signal to the drone D1 according to an instruction by the information processing apparatus 200.

In accordance with the system 10 illustrated in FIG. 7 to FIG. 9, while the drone 100 at the switching destination is flying, by transmitting, to the drone 100 set as the current operation target of the operation apparatus 50, the end signal indicating the end of the flight based on the operation signal transmitted from the operation apparatus 50 and transmitting, to the drone 100 at the switching destination, the start signal indicating the start of the flight based on the operation signal transmitted by the operation apparatus 50, the information processing apparatus 200 switches the operation target of the operation apparatus 50 from the drone 100 set as the current operation target of the operation apparatus 50 to the drone 100 at the switching destination. In response to the operation target of the operation apparatus 50 having been switched to the drone 100 at the switching destination, the drone 100 that is no longer the operation target of the operation apparatus 50 may fly in any flight mode among the autonomous flight mode, the local site operation flight mode, and the remote operation flight mode. As a result, without regularly assigning a plurality of operation apparatuses 50 to a drone 100 while the drone 100 is flying, by switching the operation target of one operation apparatus 50 among a plurality of drones 100, the plurality of drones 100 can be remotely operated by using the one operation apparatus 50. Accordingly, in the system 10 illustrated in FIG. 7 to FIG. 9, because the information processing apparatus 200 can flexibly and efficiently switch the pilot of the drone 100 while the drone 100 is flying, a configuration can be achieved in which a drone pilot having a more advanced operation technique becomes responsible for operating the drone in a flight situation with a higher operation difficulty.

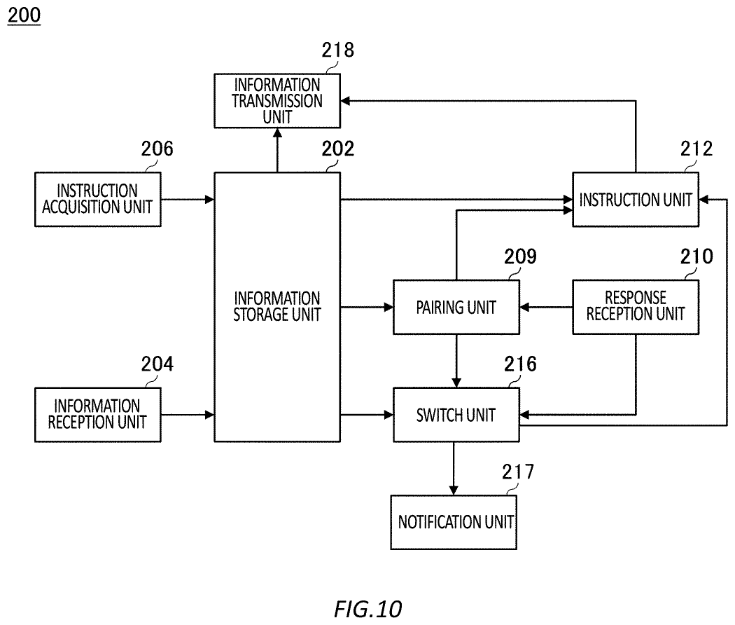

FIG. 10 schematically illustrates another example of the functional configuration of the information processing apparatus 200. The information processing apparatus 200 includes the information storage unit 202, the information reception unit 204, the instruction acquisition unit 206, a pairing unit 209, the response reception unit 210, the instruction unit 212, the switch unit 216, the notification unit 217, and the information transmission unit 218. Note that it is not necessarily required for the information processing apparatus 200 to include all of these components. Herein, different aspects of the example of the information processing apparatus 200 illustrated in FIG. 10 from the example of the information processing apparatus 200 illustrated in FIG. 6 will be mainly described.

The pairing unit 209 establishes each of a first pairing between the operation apparatus 50 and a first drone and a second pairing between the operation apparatus 50 and a second drone. The drone 100 may be an example of the first drone. The drone 100 may be an example of the second drone.

The pairing unit 209 establishes each of the first pairing between the operation apparatus 50 and the first drone and the second pairing between the operation apparatus 50 and the second drone by, for example, transmitting an IP address of the first drone and an IP address of the second drone which are stored in the information storage unit 202 to the operation apparatus and transmitting an IP address of the operation apparatus 50 which is stored in the information storage unit 202 to the first drone and the second drone. The instruction unit 212 instructs the operation apparatus 50 to start the transmission of the operation signal to the first drone and the second drone in response to, for example, the establishment of each of the first pairing between the operation apparatus 50 and the first drone and the second pairing between the operation apparatus 50 and the second drone by the pairing unit 209.

The instruction acquisition unit 206 acquires the operation target switch instruction for instructing the switching of the operation target of the operation apparatus 50 from the first drone to the second drone, for example. The switch unit 216 switches the operation target of the operation apparatus 50 from the first drone to the second drone in response to the acquisition of the operation target switch instruction by the instruction acquisition unit 206. For example, while the second drone is flying, the switch unit 216 switches the operation target of the operation apparatus 50 from the first drone to the second drone by transmitting, to the first drone, the end signal indicating the end of the flight based on the operation signal transmitted by the operation apparatus 50 and transmitting, to the second drone, the start signal indicating the start of the flight based on the operation signal transmitted by the operation apparatus 50. The switch unit 216 may switch the operation target of the operation apparatus 50 from the first drone to the second drone by transmitting the operation target switch instruction acquired by the instruction acquisition unit 206 to the operation apparatus 50.

The notification unit 217 provides an operation target switch notification indicating the switching of the operation target of the operation apparatus 50 from the first drone to the second drone, for example. The notification unit 217 provides the operation target switch notification before the switching of the operation target of the operation apparatus 50 from the first drone to the second drone by the switch unit 216, for example. The notification unit 217 provides the operation target switch notification to the user of the operation apparatus 50, for example. The switch unit 216 may switch the operation target of the operation apparatus 50 from the first drone to the second drone when the response reception unit 210 receives the notification acknowledgement response indicating the acknowledgement of the operation target switch notification from the operation apparatus 50 or the communication terminal of the user of the operation apparatus 50.

FIG. 11 schematically illustrates an example of a pairing group. An example of the pairing group illustrated in FIG. 11 is composed of M (M≥2) drones and N (N≥2) operation apparatuses. Note that M may be a number greater than N, M may be a same number as N, or M may be a number less than N.

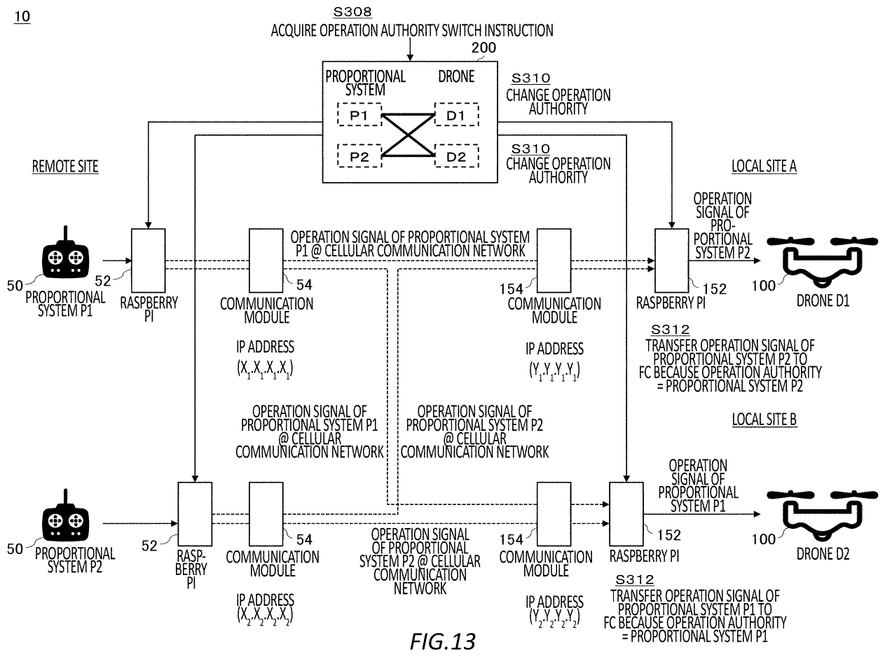

FIG. 12 and FIG. 13 are explanatory diagrams for describing another example of the process flow of the system 10. Herein, a state in which the pairing between the proportional system and the drone is not established and a drone D1 and a drone D2 remain on a ground in the remote operation flight mode will be described as a start state. Note that the information processing apparatus 200 is assumed to store pairing group information indicating a pairing group composed of the drone D1 and the drone D2, and the proportional system P1 and the proportional system P2.

In S302 of FIG. 12, the information processing apparatus 200 establishes, based on the pairing group information, each of a pairing between the proportional system P1 and the drone D1, a pairing between the proportional system P1 and the drone D2, a pairing between the proportional system P2 and the drone D1, and a pairing between the proportional system P2 and the drone D2 by writing the IP address (Y₁. Y₁. Y₁. Y₁) on the drone D1 side and the IP address (Y₂. Y₂. Y₂. Y₂) on the drone D2 side to the Raspberry Pi 52 mounted to the proportional system P1 and the Raspberry Pi 52 mounted to the proportional system P2 and writing the IP address (X₁. X₁. X₁. X₁) on the proportional system P1 side and the IP address (X₂. X₂. X₂. X₂) on the proportional system P2 side to the Raspberry Pi 152 mounted to the drone D1 and the Raspberry Pi 152 mounted to the drone D2.

In S304, the proportional system P1 starts the transmission of the operation signals which are addressed to the Raspberry Pi 152 of the drone D1 and addressed to the Raspberry Pi 152 of the drone D2 by using the communication module 54. In addition, in S304, the proportional system P2 starts the transmission of the operation signals which are addressed to the Raspberry Pi 152 of the drone D1 and addressed to the Raspberry Pi 152 of the drone D2 by using the communication module 54.

The drone D1 receives the operation signal of the proportional system P1 and the operation signal of the proportional system P2 via the cellular communication network by using the communication module 154, and transfers the operation signal of the proportional system P1 and the operation signal of the proportional system P2 which have been received to the Raspberry Pi 152. Herein, the description will continue while it is assumed that the operation apparatus 50 having the operation authority over the drone D1 in the remote operation flight mode is set to the proportional system P1.

The drone D2 receives the operation signal of the proportional system P1 and the operation signal of the proportional system P2 via the cellular communication network by using the communication module 154, and transfers the operation signal of the proportional system P1 and the operation signal of the proportional system P2 which have been received to the Raspberry Pi 152. Herein, the description will continue while it is assumed that the operation apparatus 50 having the operation authority over the drone D2 in the remote operation flight mode is set to the proportional system P2.

In S306, because the flight mode of the drone D1 is set to the remote operation flight mode and the operation apparatus 50 having the operation authority over the drone D1 is set to the proportional system P1, the Raspberry Pi 152 of the drone D1 transfers the operation signal of the proportional system P1 to the FC of the drone D1 and does not transfer the operation signal of the proportional system P2 to the FC of the drone D1. The FC of the drone D1 starts the flight of the drone D1 based on the operation signal of the proportional system P1 which has been transferred by the Raspberry Pi 152.

In addition, in S306, because the flight mode of the drone D2 is set to the remote operation flight mode and the operation apparatus 50 having the operation authority over the drone D2 is set to the proportional system P2, the Raspberry Pi 152 of the drone D2 transfers the operation signal of the proportional system P2 to the FC of the drone D2 and does not transfer the operation signal of the proportional system P1 to the FC of the drone D2. The FC of the drone D2 starts the flight of the drone D2 based on the operation signal of the proportional system P2 which has been transferred by the Raspberry Pi 152.

In S308 of FIG. 13, the information processing apparatus 200 acquires the operation authority switch instruction for instructing the switching of the operation apparatus 50 having the operation authority over the drone D1 from the proportional system P1 to the proportional system P2 and the switching of the operation apparatus 50 having the operation authority over the drone D2 from the proportional system P2 to the proportional system P1. In S310, the information processing apparatus 200 changes the operation apparatus 50 having the operation authority over the drone D1 which is stored in the Raspberry Pi 152 of the drone D1 from the proportional system P1 to the proportional system P2 by transmitting, to the drone D1, the operation authority switch signal indicating the switch from the flight based on the operation signal transmitted by the proportional system P1 to the flight based on the operation signal transmitted by the proportional system P2. In addition, in S310, the information processing apparatus 200 changes the operation apparatus 50 having the operation authority over the drone D2 which is stored in the Raspberry Pi 152 of the drone D2 from the proportional system P2 to the proportional system P1 by transmitting, to the drone D2, the operation authority switch signal indicating the switch from the flight based on the operation signal transmitted by the proportional system P2 to the flight based on the operation signal transmitted by the proportional system P1.

In response to the change in the operation apparatus 50 having the operation authority over the drone D1 in S310 from the proportional system P1 to the proportional system P2 by the information processing apparatus 200, in S312, the Raspberry Pi 152 of the drone D1 ends the transfer of the operation signal of the proportional system P1 to the FC of the drone D1 and starts the transfer of the operation signal of the proportional system P2 to the FC of the drone D1. The FC of the drone D1 controls the flight of the drone D1 based on the operation signal of the proportional system P2 which has been transferred by the Raspberry Pi 152. As a result, the operation authority switch processing for switching the operation apparatus 50 having the operation authority over the drone D1 from the proportional system P1 to the proportional system P2 by the information processing apparatus 200 is completed.

In addition, in response to the change in the operation apparatus 50 having the operation authority over the drone D2 in S310 by the information processing apparatus 200 from the proportional system P2 to the proportional system P1, in S312, the Raspberry Pi 152 of the drone D2 ends the transfer of the operation signal of the proportional system P2 to the FC of the drone D2 and starts the transfer of the operation signal of the proportional system P1 to the FC of the drone D2. The FC of the drone D2 controls the flight of the drone D2 based on the operation signal of the proportional system P1 which has been transferred by the Raspberry Pi 152. As a result, the operation authority switch processing by the information processing apparatus 200 to switch the operation apparatus 50 having the operation authority over the drone D2 from the proportional system P2 to the proportional system P1 is completed.

In accordance with the system 10 illustrated in FIG. 12 and FIG. 13, the information processing apparatus 200 establishes each of a plurality of pairings between each of a plurality of operation apparatuses 50 and each of a plurality of drones 100 based on pairing group information. The operation apparatus 50 transmits the operation signal to each of the plurality of drones 100 having established the pairing. Subsequently, while the drone 100 is flying, the information processing apparatus 200 switches the operation apparatus 50 having the operation authority over the drone 100 from the first operation apparatus to the second operation apparatus in response to the acquisition of the operation authority switch instruction for instructing the switching of the operation apparatus 50 having the operation authority over the drone 100 which belongs to the pairing group indicated by the pairing group information from the first operation apparatus belonging to the pairing group to the second operation apparatus belonging to the pairing group. Accordingly, because the information processing apparatus 200 establishes each of the plurality of pairings between each of the plurality of operation apparatuses 50 and each of the plurality of drones 100 based on the pairing group information, and the operation apparatus 50 transmits the operation signal to each of the plurality of drones 100 having established the pairing, the system 10 illustrated in FIG. 12 and FIG. 13 can switch the operation apparatus 50 having the operation authority over the drone 100 in a safer manner from the first operation apparatus to the second operation apparatus. Furthermore, because the system 10 illustrated in FIG. 12 and FIG. 13 can switch the operation apparatus 50 having the operation authority over the drone 100 by merely transmitting the operation authority switch signal to the drone 100, the operation apparatus 50 having the operation authority over the drone 100 can be switched by a lower amount of processing load of the information processing apparatus 200.

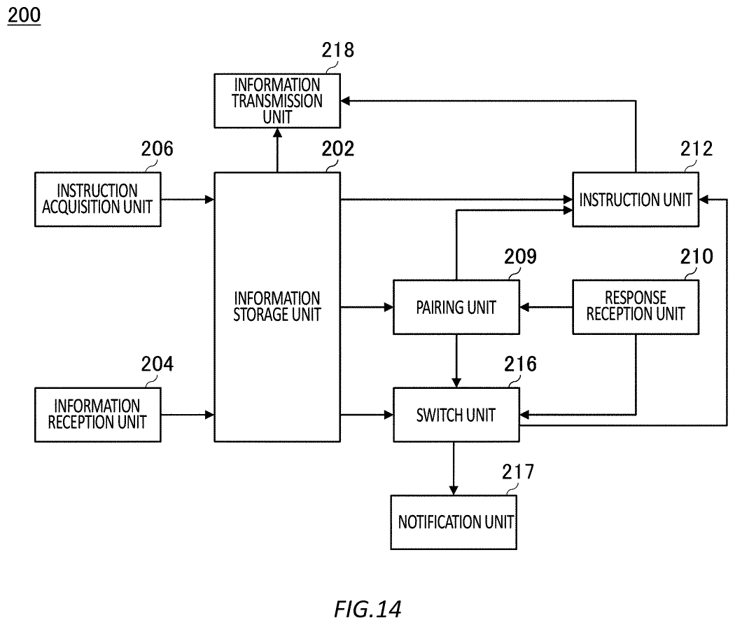

FIG. 14 schematically illustrates another example of the functional configuration of the information processing apparatus 200. The information processing apparatus 200 includes the information storage unit 202, the information reception unit 204, the instruction acquisition unit 206, a pairing unit 209, the response reception unit 210, the instruction unit 212, the switch unit 216, the notification unit 217, and the information transmission unit 218. Note that it is not necessarily required for the information processing apparatus 200 to include all of these components. Herein, different aspects of the example of the information processing apparatus 200 illustrated in FIG. 14 from the example of the information processing apparatus 200 illustrated in FIG. 6 and the example of the information processing apparatus 200 illustrated in FIG. 10 will be mainly described.

The information storage unit 202 stores pairing group information indicating a pairing group composed of, for example, a plurality of drones 100 and a plurality of operation apparatuses 50. The pairing unit 209 establishes, for example, each of a plurality of pairings between each of the plurality of operation apparatuses 50 and each of the plurality of drones 100. The pairing unit 209 establishes each of the plurality of pairings between each of the plurality of operation apparatuses 50 and each of the plurality of drones 100 by transmitting the IP address of each of the plurality of drones 100 which is stored in the information storage unit 202 to each of the plurality of operation apparatuses 50, based on, for example, the pairing group information stored in the information storage unit 202, and transmitting the IP address of each of the plurality of operation apparatuses 50 which is stored in the information storage unit 202 to each of the plurality of drones 100.

The instruction acquisition unit 206 acquires, for example, the operation authority switch instruction for instructing the switching of the operation apparatus 50 having the operation authority over the drone 100 which belongs to the pairing group indicated by the pairing group information stored in the information storage unit 202 from the first operation apparatus belonging to the pairing group to the second operation apparatus belonging to the pairing group. In response to the acquisition of the operation authority switch instruction by the instruction acquisition unit 206, while the drone 100 is flying, the switch unit 216 switches the operation apparatus 50 having the operation authority over the drone 100 from the first operation apparatus to the second operation apparatus by transmitting, to the drone 100, the operation authority switch signal indicating the switch from the flight based on the operation signal transmitted by the first operation apparatus to the flight based on the operation signal transmitted by the second operation apparatus.

FIG. 15 to FIG. 19 are explanatory diagrams for describing another example of the process flow of the system 10. Herein, a state in which the pairing between the proportional system and the drone is not established and a drone D1 and a drone D2 remain on a ground in the remote operation flight mode will be described as a start state. Note that the information processing apparatus 200 is assumed to store pairing group information indicating a pairing group composed of the drone D1 and the drone D2, and the proportional system P1 and the proportional system P2.

In S402 of FIG. 15, the information processing apparatus 200 establishes, based on the pairing group information, each of a pairing between the proportional system P1 and the drone D1, a pairing between the proportional system P1 and the drone D2, a pairing between the proportional system P2 and the drone D1, and a pairing between the proportional system P2 and the drone D2 by writing the IP address (Y₁. Y₁. Y₁. Y₁) on the drone D1 side and the IP address (Y₂. Y₂. Y₂. Y₂) on the drone D2 side to the Raspberry Pi 52 mounted to the proportional system P1 and the Raspberry Pi 52 mounted to the proportional system P2 and writing the IP address (X₁. X₁. X₁. X₁) on the proportional system P1 side and the IP address (X₂. X₂. X₂. X₂) on the proportional system P2 side to the Raspberry Pi 152 mounted to the drone D1 and the Raspberry Pi 152 mounted to the drone D2. Herein, the description will continue while it is assumed that the operation target of the proportional system P1 is set to the drone D1, and the operation target of the proportional system P2 is set to the drone D2.

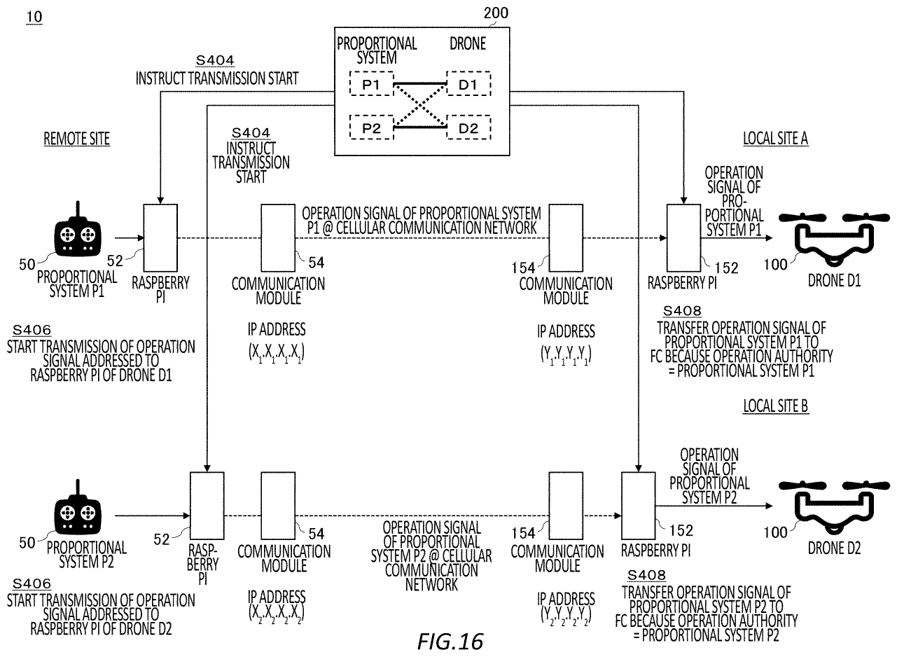

In S404 of FIG. 16, because the operation target of the proportional system P1 is set to the drone D1, the information processing apparatus 200 instructs the proportional system P1 to start the transmission of the operation signal to the drone D1. In addition, in S404, because the operation target of the proportional system P2 is set to the drone D2, the information processing apparatus 200 instructs the proportional system P2 to start the transmission of the operation signal to the drone D2.

In S406, the proportional system P1 starts the transmission of the operation signal addressed to the Raspberry Pi 152 of the drone D1 according to the instruction by the information processing apparatus 200 in S404. The drone D1 receives the operation signal of the proportional system P1 via the cellular communication network by using the communication module 154, and transfers the received operation signal of the proportional system P1 to the Raspberry Pi 152. Herein, the description will continue while it is assumed that the operation apparatus 50 having the operation authority over the drone D1 in the remote operation flight mode is set to the proportional system P1.

In addition, in S406, the proportional system P2 starts the transmission of the operation signal addressed to the Raspberry Pi 152 of the drone D2 according to the instruction by the information processing apparatus 200 in S404. The drone D2 receives the operation signal of the proportional system P2 via the cellular communication network by using the communication module 154, and transfers the received operation signal of the proportional system P2 to the Raspberry Pi 152. Herein, the description will continue while it is assumed that the operation apparatus 50 having the operation authority over the drone D2 in the remote operation flight mode is set to the proportional system P2.

In S408, the Raspberry Pi 152 of the drone D1 transfers the operation signal of the proportional system P1 to the FC of the drone D1 because the flight mode of the drone D1 is set to the remote operation flight mode and the operation apparatus 50 having the operation authority over the drone D1 is set to the proportional system P1. The FC of the drone D1 starts the flight of the drone D1 based on the operation signal of the proportional system P1 which has been transferred by the Raspberry Pi 152.

In addition, in S408, the Raspberry Pi 152 of the drone D2 transfers the operation signal of the proportional system P2 to the FC of the drone D2 because the flight mode of the drone D2 is set to the remote operation flight mode and the operation apparatus 50 having the operation authority over the drone D2 is set to the proportional system P2. The FC of the drone D2 starts the flight of the drone D2 based on the operation signal of the proportional system P2 which has been transferred by the Raspberry Pi 152.

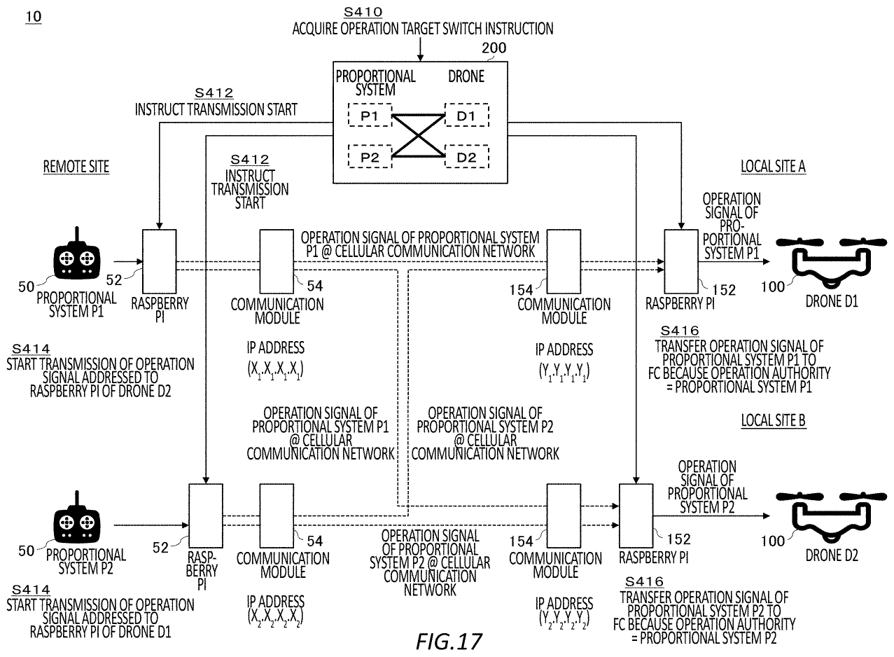

In S410 of FIG. 17, the information processing apparatus 200 acquires the operation target switch instruction for instructing the switching of the operation target of the proportional system P1 from the drone D1 to the drone D2 and the switching of the operation target of the proportional system P2 from the drone D2 to the drone D1. In S412, the information processing apparatus 200 instructs the proportional system P1 to start the transmission of the operation signal to the drone D2 in response to the acquisition of the operation target switch instruction in S410. In addition, in response to the acquisition of the operation target switch instruction in S410, the information processing apparatus 200 instructs the proportional system P2 to start the transmission of the operation signal to the drone D1 in S412.

In S414, the proportional system P1 starts the transmission of the operation signal addressed to the Raspberry Pi 152 of the drone D2 in addition to the transmission of the operation signal addressed to the Raspberry Pi 152 of the drone D1 according to the instruction by the information processing apparatus 200 in S412. The drone D2 receives the operation signal of the proportional system P1 via the cellular communication network by using the communication module 154, and transfers the received operation signal of the proportional system P1 to the Raspberry Pi 152.

In addition, in S414, the proportional system P2 starts the transmission of the operation signal addressed to the Raspberry Pi 152 of the drone D1 in addition to the transmission of the operation signal addressed to the Raspberry Pi 152 of the drone D2 according to the instruction by the information processing apparatus 200 in S412. The drone D1 receives the operation signal of the proportional system P2 via the cellular communication network by using the communication module 154, and transfers the received operation signal of the proportional system P2 to the Raspberry Pi 152.

In S416, the Raspberry Pi 152 of the drone D1 transfers the operation signal of the proportional system P1 to the FC of the drone D1 and does not transfer the operation signal of the proportional system P2 to the FC of the drone D1 because the flight mode of the drone D1 is set to the remote operation flight mode and the operation apparatus 50 having the operation authority over the drone D1 is set to the proportional system P1. In addition, in S416, the Raspberry Pi 152 of the drone D2 transfers the operation signal of the proportional system P2 to the FC of the drone D2 and does not transfer the operation signal of the proportional system P1 to the FC of the drone D2 because the flight mode of the drone D2 is set to the remote operation flight mode and the operation apparatus 50 having the operation authority over the drone D2 is set to the proportional system P1.

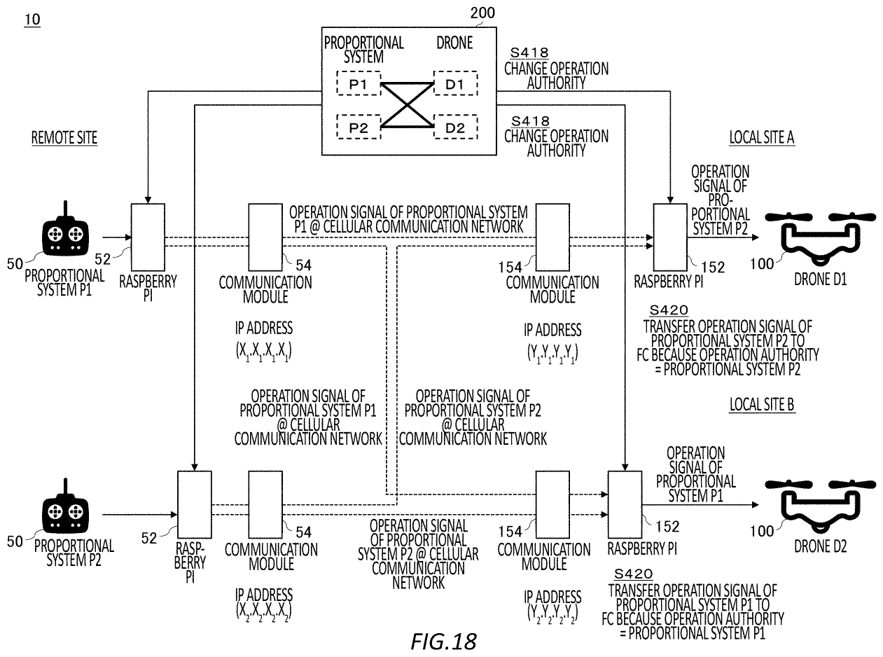

In S418 of FIG. 18, the information processing apparatus 200 changes the operation apparatus 50 having the operation authority over the drone D1 which is stored in the Raspberry Pi 152 of the drone D1 from the proportional system P1 to the proportional system P2 by transmitting, to the drone D1, the operation authority switch signal which includes the end signal indicating the end of the flight based on the operation signal transmitted by the proportional system P1 and the start signal indicating the start of the flight based on the operation signal transmitted by the proportional system P2. In addition, in S418, the information processing apparatus 200 changes the operation apparatus 50 having the operation authority over the drone D2 which is stored in the Raspberry Pi 152 of the drone D2 from the proportional system P2 to the proportional system P1 by transmitting, to the drone D2, the operation authority switch signal which includes the end signal indicating the end of the flight based on the operation signal transmitted by the proportional system P2 and the start signal indicating the start of the flight based on the operation signal transmitted by the proportional system P1.

In response to the change in the operation apparatus 50 having the operation authority over the drone D1 in S418 by the information processing apparatus 200 from the proportional system P1 to the proportional system P2, in S420, the Raspberry Pi 152 of the drone D1 ends the transfer of the operation signal of the proportional system P1 to the FC of the drone D1 and starts the transfer of the operation signal of the proportional system P2 to the FC of the drone D1. The FC of the drone D1 controls the flight of the drone D1 based on the operation signal of the proportional system P2 which has been transferred by the Raspberry Pi 152. As a result, the operation target switch processing by the information processing apparatus 200 to switch the operation target of the proportional system P1 from the drone D1 to the drone D2 is completed.

In addition, in response to the change in the operation apparatus 50 having the operation authority over the drone D2 in S418 by the information processing apparatus 200 from the proportional system P2 to the proportional system P1, in S420, the Raspberry Pi 152 of the drone D2 ends the transfer of the operation signal of the proportional system P2 to the FC of the drone D2 and starts the transfer of the operation signal of the proportional system P1 to the FC of the drone D2. The FC of the drone D2 controls the flight of the drone D2 based on the operation signal of the proportional system P1 which has been transferred by the Raspberry Pi 152. As a result, the operation target switch processing by the information processing apparatus 200 to switch the operation target of the proportional system P2 from the drone D2 to the drone D1 is completed.

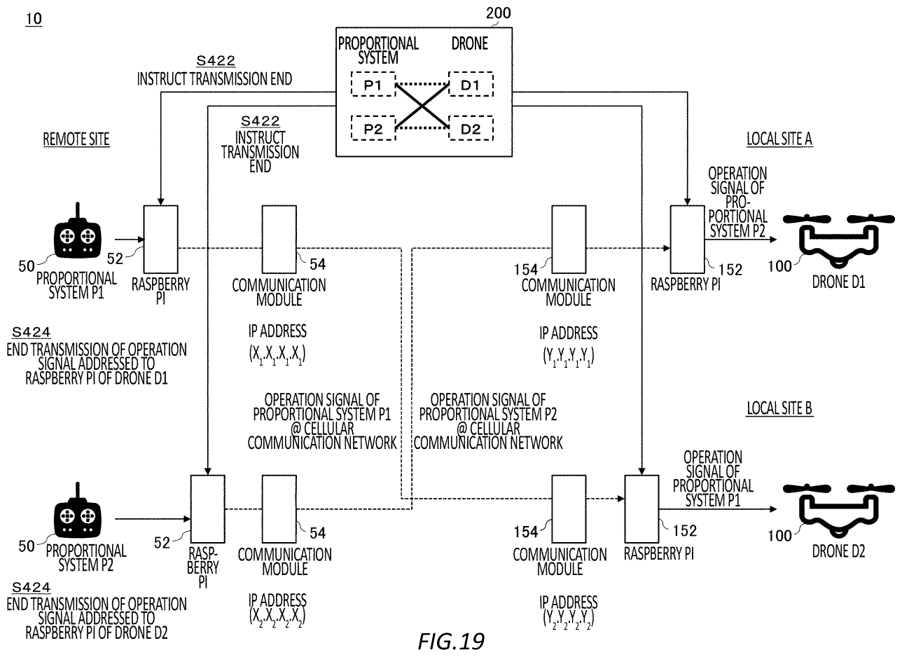

In response to the completion of the switching of the operation target of the proportional system P1 in S420 from the drone D1 to the drone D2, in S422 of FIG. 19, the information processing apparatus 200 instructs the proportional system P1 to end the transmission of the operation signal to the drone D1. In addition, in response to the completion of the switching of the operation target of the proportional system P2 in S420 from the drone D2 to the drone D1, in S422, the information processing apparatus 200 instructs the proportional system P2 to end the transmission of the operation signal to the drone D2.

In S424, the proportional system P1 ends the transmission of the operation signal addressed to the Raspberry Pi 152 of the drone D1 according to the instruction by the information processing apparatus 200 in S422. In addition, in S424, the proportional system P2 ends the transmission of the operation signal addressed to the Raspberry Pi 152 of the drone D2 according to the instruction by the information processing apparatus 200 in S422.

In accordance with the system 10 illustrated in FIG. 15 to FIG. 19, the information processing apparatus 200 establishes each of the plurality of pairings between each of the plurality of operation apparatuses 50 and each of the plurality of drones 100 based on the pairing group information. Furthermore, the information processing apparatus 200 instructs the operation apparatus 50 to start the transmission of the operation signal to the first drone belonging to the pairing group that is the operation target of the operation apparatus 50 belonging to the pairing group indicated by the pairing group information. The operation apparatus 50 starts the transmission of the operation signal to the first drone according to the instruction by the information processing apparatus 200. As a result, the operation apparatus 50 is set to transmit the operation signal to the first drone. Next, in response to the acquisition of the operation target switch instruction for instructing the switching of the operation target of the operation apparatus 50 from the first operation apparatus to the second operation apparatus belonging to the pairing group, the information processing apparatus 200 instructs the operation apparatus 50 to start the transmission of the operation signal to the second drone. The operation apparatus 50 starts the transmission of the operation signal to the second drone according to the instruction by the information processing apparatus 200. As a result, the operation apparatus 50 is set to transmit the operation signals to the first drone and the second drone. Subsequently, while the second drone is flying, the information processing apparatus 200 switches the operation target of the operation apparatus 50 from the first drone to the second drone. Furthermore, in response to the completion of the switching of the operation target of the operation apparatus 50, the information processing apparatus 200 instructs the operation apparatus 50 to end the transmission of the operation signal to the first drone. The operation apparatus 50 ends the transmission of the operation signal to the first drone according to the instruction by the information processing apparatus 200. As a result, the operation apparatus 50 is set to transmit the operation signal to only the second drone. Accordingly, by causing the operation apparatus 50 to transmit the operation signals to both the drone 100 that is the current operation target and the drone 100 at the switching destination only at the timing at which the information processing apparatus 200 switches the operation target of the operation apparatus 50, the system 10 illustrated in FIG. 15 to FIG. 19 can suppress the transmission of unnecessary operation signals that are not transferred to the FC of the drone 100 and can switch the operation target of the operation apparatus 50 with reduced communication resources from the first drone to the second drone.

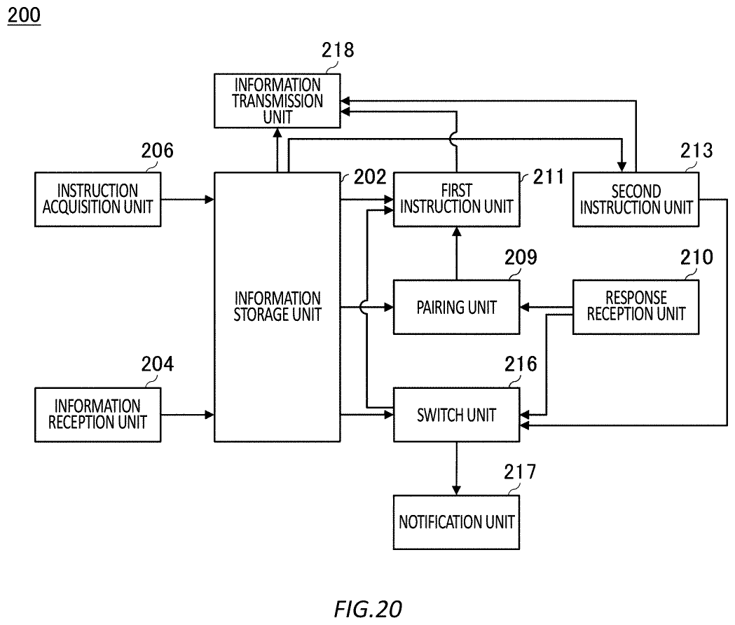

FIG. 20 schematically illustrates another example of the functional configuration of the information processing apparatus 200. The information processing apparatus 200 includes the information storage unit 202, the information reception unit 204, the instruction acquisition unit 206, the pairing unit 209, the response reception unit 210, a first instruction unit 211, a second instruction unit 213, the switch unit 216, the notification unit 217, and the information transmission unit 218. Note that it is not necessarily required for the information processing apparatus 200 to include all of these components. Herein, different aspects of the example of the information processing apparatus 200 illustrated in FIG. 20 from the example of the information processing apparatus 200 illustrated in FIG. 6, the example of the information processing apparatus 200 illustrated in FIG. 10, and the example of the information processing apparatus 200 illustrated in FIG. 14 will be mainly described.

The first instruction unit 211 instructs the operation apparatus 50 to start the transmission of the operation signal to the first drone belonging to the pairing group that is the operation target of the operation apparatus 50 belonging to the pairing group indicated by the pairing group information stored in the information storage unit 202. The first instruction unit 211 instructs the operation apparatus 50 to start the transmission of the operation signal to the first drone in response to, for example, the establishment of the pairing between the operation apparatus 50 and the first drone by the pairing unit 209.

The instruction acquisition unit 206 acquires the operation target switch instruction for instructing the switching of the operation target of the operation apparatus 50, for example, from the first drone to the second drone belonging to the pairing group. The second instruction unit 213 instructs the operation apparatus 50 to start the transmission of the operation signal to the second drone in response to the acquisition of the operation target switch instruction by the instruction acquisition unit 206.

For example, in response to the second instruction unit 213 having instructed the operation apparatus 50 to start the transmission of the operation signal to the second drone, while the second drone is flying, the switch unit 216 switches the operation target of the operation apparatus 50 from the first drone to the second drone by transmitting, to the first drone, the end signal indicating the end of the flight based on the operation signal transmitted by the operation apparatus 50, and transmitting, to the second drone, the start signal indicating the start of the flight based on the operation signal transmitted by the operation apparatus 50. The first instruction unit 211 may instruct the operation apparatus 50 to end the transmission of the operation signal to the first drone in response to the completion of the switching of the operation target of the operation apparatus 50 by the switch unit 216.

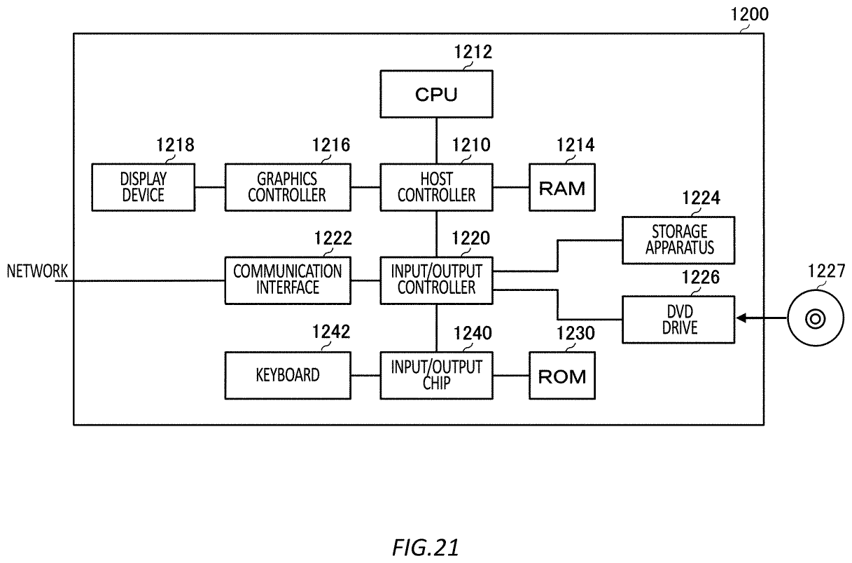

FIG. 21 schematically illustrates an example of a hardware configuration of a computer 1200 that functions as the information processing apparatus 200. Programs installed in the computer 1200 can cause the computer 1200 to function as one or more “units” of the apparatus according to the above-described embodiment or can cause the computer 1200 to execute operations associated with the apparatuses according to the above-described embodiment or said one or more “units”, and/or can cause the computer 1200 to execute a process according to the above-described embodiment or steps of said process. Such a program may be executed by a CPU 1212 to cause the computer 1200 to perform particular operations associated with some or all of the blocks in the flowcharts and block diagrams described in the present specification.

The computer 1200 according to the present embodiment includes the CPU 1212, a RAM 1214, and a graphics controller 1216, which are connected to each other via a host controller 1210. The computer 1200 also includes a communication interface 1222, a storage apparatus 1224, a DVD drive 1226, and an input/output unit such as an IC card drive, which are connected to the host controller 1210 via an input/output controller 1220. The DVD drive 1226 may be a DVD-ROM drive, a DVD-RAM drive, and the like. The storage apparatus 1224 may be a hard disk drive, a solid-state drive, and the like. The computer 1200 also includes legacy input/output units such as a ROM 1230 and a keyboard 1242, which are connected to the input/output controller 1220 through an input/output chip 1240.

The CPU 1212 operates in accordance with the programs stored in the ROM 1230 and the RAM 1214, thereby controlling each unit. The graphics controller 1216 acquires image data which is generated by the CPU 1212 in a frame buffer or the like provided in the RAM 1214 or in itself so as to cause the image data to be displayed on a display device 1218.

The communication interface 1222 communicates with other electronic devices via a network. The storage apparatus 1224 stores a program and data used by the CPU 1212 in the computer 1200. The DVD drive 1226 reads the programs or the data from the DVD-ROM 1227 or the like, and provides the storage apparatus 1224 with the programs or the data. The IC card drive reads the program and data from an IC card, and/or writes the program and data to the IC card.

The ROM 1230 stores therein a boot program or the like executed by the computer 1200 at the time of activation, and/or a program depending on the hardware of the computer 1200. The input/output chip 1240 may also connect various input/output units via a USB port, a parallel port, a serial port, a keyboard port, a mouse port, or the like to the input/output controller 1220.

A program is provided by a computer readable storage medium such as the DVD-ROM 1227 or the IC card. The program is read from the computer readable storage medium, installed into the storage apparatus 1224, RAM 1214, or ROM 1230, which are also examples of a computer readable storage medium, and executed by the CPU 1212. Information processing written in these programs is read by the computer 1200, and provides cooperation between the programs and the various types of hardware resources described above. An apparatus or method may be configured by achieving the operation or processing of information in accordance with the usage of the computer 1200.

For example, when a communication is performed between the computer 1200 and an external device, the CPU 1212 may execute a communication program loaded in the RAM 1214 and instruct the communication interface 1222 to perform communication processing based on a process written in the communication program. The communication interface 1222, under control of the CPU 1212, reads transmission data stored on a transmission buffer region provided in a recording medium such as the RAM 1214, the storage apparatus 1224, the DVD-ROM 1227, or the IC card, and transmits the read transmission data to a network or writes reception data received from a network to a reception buffer region or the like provided on the recording medium.

In addition, the CPU 1212 may cause all or a necessary portion of a file or a database, which has been stored in an external recording medium such as the storage apparatus 1224, the DVD drive 1226 (DVD-ROM 1227), the IC card and the like, to be read into the RAM 1214, thereby executing various types of processing on the data on the RAM 1214. Next, the CPU 1212 may write the processed data back into the external recording medium.

Various types of information, such as various types of programs, data, tables, and databases, may be stored in the recording medium to undergo information processing. The CPU 1212 may execute, on the data read from the RAM 1214, various types of processing including various types of operations, information processing, conditional judgement, conditional branching, unconditional branching, information search/replacement, or the like described throughout the present disclosure and designated by instruction sequences of the programs, to write the results back to the RAM 1214. In addition, the CPU 1212 may search for information in a file, a database, or the like in the recording medium. For example, when a plurality of entries, each having an attribute value of a first attribute associated with an attribute value of a second attribute, are stored in the recording medium, the CPU 1212 may search for an entry whose attribute value of the first attribute matches a designated condition, from among the plurality of entries, and read the attribute value of the second attribute stored in the entry, thereby acquiring the attribute value of the second attribute associated with the first attribute that satisfies a predetermined condition.

The programs or software module described above may be stored on the computer 1200 or in a computer readable storage medium near the computer 1200. In addition, a recording medium such as a hard disk or a RAM provided in a server system connected to a dedicated communication network or the Internet can be used as the computer readable storage medium, thereby providing the program to the computer 1200 via the network.

Blocks in flowcharts and block diagrams in the present embodiments may represent steps of processes in which operations are executed or “units” of apparatuses responsible for executing operations. A specific step and “unit” may be implemented by a dedicated circuit, a programmable circuit supplied along with a computer readable instruction stored on a computer readable storage medium, and/or a processor supplied along with the computer readable instruction stored on the computer readable storage medium. The dedicated circuit may include a digital and/or analog hardware circuit, or may include an integrated circuit (IC) and/or a discrete circuit. The programmable circuit may include, for example, a reconfigurable hardware circuit including logical AND, logical OR, logical XOR, logical NAND, logical NOR, and another logical operation, and a flip-flop, a register, and a memory element, such as a field programmable gate array (FPGA), a programmable logic array (PLA), or the like.

The computer readable storage medium may include any tangible device capable of storing an instruction executed by an appropriate device, so that the computer readable storage medium having the instruction stored thereon constitutes a product including an instruction that may be executed in order to provide means for executing an operation designated by a flowchart or a block diagram. An example of the computer readable storage medium may include an electronic storage medium, a magnetic storage medium, an optical storage medium, an electromagnetic storage medium, a semiconductor storage medium, etc. A more specific example of the computer readable storage medium may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disk read-only memory (CD-ROM), a digital versatile disk (DVD), a Blu-ray (registered trademark) disk, a memory stick, an integrated circuit card, or the like.

The computer readable instructions may include an assembler instruction, an instruction-set-architecture (ISA) instruction, a machine instruction, a machine-dependent instruction, a microcode, a firmware instruction, state-setting data, or either of a source code or an object code written in any combination of one or more programming languages including an object-oriented programming language such as Smalltalk (registered trademark), JAVA (registered trademark), and C++, or the like, and a conventional procedural programming language such as a “C” programming language or a similar programming language.

The computer readable instruction may be provided to a general purpose computer, a special purpose computer, or a processor or programmable circuit of another programmable data processing apparatus locally or via a local area network (LAN), a wide area network (WAN) such as the Internet or the like in order that the general purpose computer, the special purpose computer, or the processor or the programmable circuit of another programmable data processing apparatus executes the computer readable instruction to generate means for executing operations designated by the flowchart or the block diagram. Examples of the processor include a computer processor, a processing unit, a microprocessor, a digital signal processor, a controller, a microcontroller, and the like.

While the embodiments of the present invention have been described, the technical scope of the present invention is not limited to the above-described embodiments. It is apparent to persons skilled in the art that various alterations or improvements can be added to the above-described embodiments. It is also apparent from the scope of the claims that the embodiments added with such alterations or improvements can be included in the technical scope of the present invention.

The operations, procedures, steps, and stages of each process executed by an apparatus, system, program, and method shown in the claims, embodiments, or diagrams can be achieved in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be executed in this order.

### EXPLANATION OF REFERENCES

10: system; 20: network; 42: base station; 44: base station; 50: operation apparatus; 52: Raspberry Pi; 54: communication module; 55: user; 57: user; 60: operation apparatus; 65: user; 67: user; 85: display; 87: display; 100: drone; 120: camera; 150: control apparatus; 152: Raspberry Pi; 154: communication module; 200: information processing apparatus; 202: information storage unit; 204: information reception unit; 206: instruction acquisition unit; 208: first pairing unit; 209: pairing unit; 210: response reception unit; 211: first instruction unit; 212: instruction unit; 213: second instruction unit; 214: second pairing unit; 216: switch unit; 217: notification unit; 218: information transmission unit; 250: wireless communication module; 1200: computer; 1210: host controller; 1212: CPU; 1214: RAM; 1216: graphics controller; 1218: display device; 1220 input/output controller; 1222: communication interface; 1224: storage apparatus; 1226: DVD drive; 1227: DVD-ROM; 1230: ROM; 1240: input/output chip; 1242: keyboard.

What is claimed is:

1. An information processing apparatus comprising:
a first pairing unit which establishes, by transmitting an IP (internet protocol) address of a drone to a first operation apparatus and transmitting an IP address of the first operation apparatus to the drone, a first pairing between the first operation apparatus and the drone;
an instruction acquisition unit which acquires an operation authority switch instruction for instructing switching of an operation apparatus having an operation authority over the drone from the first operation apparatus to a second operation apparatus;
a second pairing unit which establishes, in response to the instruction acquisition unit having acquired the operation authority switch instruction, while the drone is flying, by transmitting the IP address of the drone to the second operation apparatus and transmitting an IP address of the second operation apparatus to the drone, a second pairing between the second operation apparatus and the drone; and
a switch unit which switches, in response to the second pairing unit having established the second pairing, by transmitting, to the drone, an operation authority switch signal indicating switch from a flight based on an operation signal transmitted by the first operation apparatus to a flight based on an operation signal transmitted by the second operation apparatus, the operation apparatus having the operation authority over the drone from the first operation apparatus to the second operation apparatus.

2. An information processing apparatus comprising:
a pairing unit which establishes, by transmitting an IP address of a first drone and an IP address of a second drone to an operation apparatus and transmitting an IP address of the operation apparatus to the first drone and the second drone, each of a first pairing between the operation apparatus and the first drone and a second pairing between the operation apparatus and the second drone;
an instruction acquisition unit which acquires an operation target switch instruction for instructing switching of an operation target of the operation apparatus from the first drone to the second drone; and
a switch unit which switches, in response to the instruction acquisition unit having acquired the operation target switch instruction, while the second drone is flying, by transmitting, to the first drone, an end signal indicating end of a flight based on an operation signal transmitted by the operation apparatus and transmitting, to the second drone, a start signal indicating start of a flight based on an operation signal transmitted by the operation apparatus, the operation target of the operation apparatus from the first drone to the second drone.

3. The information processing apparatus according to claim 2, further comprising:
an information storage unit which stores pairing group information indicating a pairing group composed of a plurality of drones and a plurality of operation apparatuses;
a first instruction unit which instructs the operation apparatus to start transmission of an operation signal to a first drone belonging to the pairing group that is an operation target of the operation apparatus belonging to the pairing group; and
a second instruction unit which instructs, in response to the instruction acquisition unit having acquired the operation target switch instruction, the operation apparatus to start transmission of an operation signal to the second drone, wherein
the pairing unit establishes each of a plurality of pairings between each of the plurality of operation apparatuses and each of the plurality of drones based on the pairing group information by transmitting an IP address of each of the plurality of drones to each of the plurality of operation apparatuses and transmitting an IP address of each of the plurality of operation apparatuses to each of the plurality of drones,
the instruction acquisition unit acquires the operation target switch instruction for instructing switching of the operation target of the operation apparatus from the first drone to the second drone belonging to the pairing group,
the switch unit switches, in response to the second instruction unit having instructed the operation apparatus to start transmission of an operation signal to the second drone, while the second drone is flying, the operation target of the operation apparatus from the first drone to the second drone by transmitting the end signal to the first drone and transmitting the start signal to the second drone, and
the first instruction unit instructs, in response to completion of the switching of the operation target of the operation apparatus by the switch unit, the operation apparatus to end the transmission of the operation signal to the first drone.

4. An information processing apparatus comprising:
an information storage unit which stores pairing group information indicating a pairing group composed of a plurality of drones and a plurality of operation apparatuses;
a pairing unit which establishes, based on the pairing group information, by transmitting an IP address of each of the plurality of drones to each of the plurality of operation apparatuses and transmitting an IP address of each of the plurality of operation apparatuses to each of the plurality of drones, each of a plurality of pairings between each of the plurality of operation apparatuses and each of the plurality of drones;
an instruction acquisition unit which acquires an operation authority switch instruction for instructing switching of an operation apparatus having an operation authority over a drone belonging to the pairing group from a first operation apparatus belonging to the pairing group to a second operation apparatus belonging to the pairing group; and
a switch unit which switches, in response to the instruction acquisition unit having acquired the operation authority switch instruction, while the drone is flying, by transmitting, to the drone, an operation authority switch signal indicating switch from a flight based on an operation signal transmitted by the first operation apparatus to a flight based on an operation signal transmitted by the second operation apparatus, the operation apparatus having the operation authority over the drone from the first operation apparatus to the second operation apparatus.

5. A program for causing a computer to function as:
a first pairing unit which establishes, by transmitting an IP address of a drone to a first operation apparatus and transmitting an IP address of the first operation apparatus to the drone, a first pairing between the first operation apparatus and the drone;
an instruction acquisition unit which acquires an operation authority switch instruction for instructing switching of an operation apparatus having an operation authority over the drone from the first operation apparatus to a second operation apparatus;
a second pairing unit which establishes, in response to the instruction acquisition unit having acquired the operation authority switch instruction, while the drone is flying, by transmitting the IP address of the drone to the second operation apparatus and transmitting an IP address of the second operation apparatus to the drone, a second pairing between the second operation apparatus and the drone; and
a switch unit which switches, in response to the second pairing unit having established the second pairing, by transmitting, to the drone, an operation authority switch signal indicating switch from a flight based on an operation signal transmitted by the first operation apparatus to a flight based on an operation signal transmitted by the second operation apparatus, the operation apparatus having the operation authority over the drone from the first operation apparatus to the second operation apparatus.

6. A program for causing a computer to function as:
a pairing unit which establishes, by transmitting an IP address of a first drone and an IP address of a second drone to an operation apparatus and transmitting an IP address of the operation apparatus to the first drone and the second drone, each of a first pairing between the operation apparatus and the first drone and a second pairing between the operation apparatus and the second drone;
an instruction acquisition unit which acquires an operation target switch instruction for instructing switching of an operation target of the operation apparatus from the first drone to the second drone; and
a switch unit which switches, in response to the instruction acquisition unit having acquired the operation target switch instruction, while the second drone is flying, by transmitting, to the first drone, an end signal indicating end of a flight based on an operation signal transmitted by the operation apparatus and transmitting, to the second drone, a start signal indicating start of a flight based on an operation signal transmitted by the operation apparatus, the operation target of the operation apparatus from the first drone to the second drone.

7. The program according to claim 6, wherein the computer is caused to further function as:
an information storage unit which stores pairing group information indicating a pairing group composed of a plurality of drones and a plurality of operation apparatuses;
a first instruction unit which instructs the operation apparatus to start transmission of an operation signal to a first drone belonging to the pairing group that is an operation target of the operation apparatus belonging to the pairing group; and
a second instruction unit which instructs, in response to the instruction acquisition unit having acquired the operation target switch instruction, the operation apparatus to start transmission of an operation signal to the second drone, wherein
the pairing unit establishes each of a plurality of pairings between each of the plurality of operation apparatuses and each of the plurality of drones based on the pairing group information by transmitting an IP address of each of the plurality of drones to each of the plurality of operation apparatuses and transmitting an IP address of each of the plurality of operation apparatuses to each of the plurality of drones,
the instruction acquisition unit acquires the operation target switch instruction for instructing switching of the operation target of the operation apparatus from the first drone to the second drone belonging to the pairing group,
the switch unit switches, in response to the second instruction unit having instructed the operation apparatus to start transmission of an operation signal to the second drone, while the second drone is flying, the operation target of the operation apparatus from the first drone to the second drone by transmitting the end signal to the first drone and transmitting the start signal to the second drone, and
the first instruction unit instructs, in response to completion of the switching of the operation target of the operation apparatus by the switch unit, the operation apparatus to end the transmission of the operation signal to the first drone.

8. A program for causing a computer to function as:
an information storage unit which stores pairing group information indicating a pairing group composed of a plurality of drones and a plurality of operation apparatuses;
a pairing unit which establishes, based on the pairing group information, by transmitting an IP address of each of the plurality of drones to each of the plurality of operation apparatuses and transmitting an IP address of each of the plurality of operation apparatuses to each of the plurality of drones, each of a plurality of pairings between each of the plurality of operation apparatuses and each of the plurality of drones;
an instruction acquisition unit which acquires an operation authority switch instruction for instructing switching of an operation apparatus having an operation authority over a drone belonging to the pairing group from a first operation apparatus belonging to the pairing group to a second operation apparatus belonging to the pairing group; and
a switch unit which switches, in response to the instruction acquisition unit having acquired the operation authority switch instruction, while the drone is flying, by transmitting, to the drone, an operation authority switch signal indicating switch from a flight based on an operation signal transmitted by the first operation apparatus to a flight based on an operation signal transmitted by the second operation apparatus, the operation apparatus having the operation authority over the drone from the first operation apparatus to the second operation apparatus.

9. A system comprising:
the information processing apparatus according to claim 1;
the drone;
the first operation apparatus; and
the second operation apparatus.

10. A system comprising:
the information processing apparatus according to claim 2;
the first drone;
the second drone; and
the operation apparatus.

11. A system comprising:
the information processing apparatus according to claim 3;
the plurality of drones; and
the plurality of operation apparatuses.

12. A system comprising:
the information processing apparatus according to claim 4;
the plurality of drones; and
the plurality of operation apparatuses.

13. An information processing method performed by a computer, the information processing method comprising:
establishing, by transmitting an IP address of a drone to a first operation apparatus and transmitting an IP address of the first operation apparatus to the drone, a first pairing between the first operation apparatus and the drone;
acquiring an operation authority switch instruction for instructing switching of an operation apparatus having an operation authority over the drone from the first operation apparatus to a second operation apparatus;
establishing, in response to acquisition of the operation authority switch instruction in the acquiring the operation authority switch instruction, while the drone is flying, by transmitting the IP address of the drone to the second operation apparatus and transmitting an IP address of the second operation apparatus to the drone, a second pairing between the second operation apparatus and the drone;
switching, in response to establishment of the second pairing in the establishing the second pairing, by transmitting, to the drone, an operation authority switch signal indicating switch from a flight based on an operation signal transmitted by the first operation apparatus to a flight based on an operation signal transmitted by the second operation apparatus, the operation apparatus having the operation authority over the drone from the first operation apparatus to the second operation apparatus.

14. An information processing method performed by a computer, the information processing method comprising:
establishing, by transmitting an IP address of a first drone and an IP address of a second drone to an operation apparatus and transmitting an IP address of the operation apparatus to the first drone and the second drone, each of a first pairing between the operation apparatus and the first drone and a second pairing between the operation apparatus and the second drone;
acquiring an operation target switch instruction for instructing switching of an operation target of the operation apparatus from the first drone to the second drone; and
switching, in response to acquisition of the operation target switch instruction in the acquiring the operation target switch instruction, while the second drone is flying, by transmitting, to the first drone, an end signal indicating end of a flight based on an operation signal transmitted by the operation apparatus and transmitting, to the second drone, a start signal indicating start of a flight based on an operation signal transmitted by the operation apparatus, the operation target of the operation apparatus from the first drone to the second drone.

15. The information processing method according to claim 14, the information processing method being executed by the computer storing pairing group information indicating a pairing group composed of a plurality of drones and a plurality of operation apparatuses, the information processing method further comprising:
first instructing the operation apparatus to start transmission of an operation signal to the first drone belonging to the pairing group that is an operation target of the operation apparatus belonging to the pairing group; and
second instructing, in response to acquisition of the operation target switch instruction in the acquiring the operation target switch instruction, the operation apparatus to start transmission of an operation signal to the second drone, wherein
the pairing includes establishing each of a plurality of pairings between each of the plurality of operation apparatuses and each of the plurality of drones based on the pairing group information by transmitting an IP address of each of the plurality of drones to each of the plurality of operation apparatuses and transmitting an IP address of each of the plurality of operation apparatuses to each of the plurality of drones,
the acquiring the operation target switch instruction includes acquiring the operation target switch instruction for instructing switching of the operation target of the operation apparatus from the first drone to the second drone belonging to the pairing group,
the switching includes switching, in response to having instructed the operation apparatus to start transmission of an operation signal to the second drone in the second instructing, while the second drone is flying, the operation target of the operation apparatus from the first drone to the second drone by transmitting the end signal to the first drone and transmitting the start signal to the second drone, and
the first instructing includes instructing, in response to completion of the switching of the operation target of the operation apparatus in the switching, the operation apparatus to end the transmission of the operation signal to the first drone.

16. An information processing method performed by a computer, the information processing method comprising:
establishing, based on pairing group information which is stored in the computer and which indicates a pairing group composed of a plurality of drones and a plurality of operation apparatuses, by transmitting an IP address of each of the plurality of drones to each of the plurality of operation apparatuses and transmitting an IP address of each of the plurality of operation apparatuses to each of the plurality of drones, each of a plurality of pairings between each of the plurality of operation apparatuses and each of the plurality of drones;
acquiring an operation authority switch instruction for instructing switching of an operation apparatus having an operation authority over a drone belonging to the pairing group from a first operation apparatus belonging to the pairing group to a second operation apparatus belonging to the pairing group; and
switching, in response to acquisition of the operation authority switch instruction in the acquiring the operation authority switch instruction, while the drone is flying, by transmitting, to the drone, an operation authority switch signal indicating switch from a flight based on an operation signal transmitted by the first operation apparatus to a flight based on an operation signal transmitted by the second operation apparatus, the operation apparatus having the operation authority over the drone from the first operation apparatus to the second operation apparatus.
